(19) United States
(12) Patent Application Publication
(10) Pub. No.: US 2007/0004577 A1
(43) Pub. Date: Jan. 4, 2007

(54) Centrifuge assembly

(76) Inventor: Gabor Lederer, Paterson, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/170,488

(22) Filed: Jun. 29, 2005

(51) Int. Cl. B04B 5/02

(52) U.S. Cl. 494/20

(57) ABSTRACT

A centrifuge system includes a drive motor mounted independently relative to a sample carrier to eliminate detrimental forces born by a motor drive shaft. The rotatable sample carrier or tray includes a rotating center operably connected to the drive motor. The drive motor cooperates with a resilient mounting system enabling self-centering, force and vibration compensation, and improving motor life. The rotatable sample tray and a sample tube holder have respective operably cooperative contoured surfaces enabling relative smooth pivoting motion in the sample tube holder during rotation, while minimizing sample vibration, and improving the desired sample separation while minimizing sample remixing. An air management system enables effective motor cooling and minimizes sample heating.

### PRIOR RELATED APPLICATIONS

This application is a continuation-in-part and claims priority to PCT Patent Application, Ser. No. PCT/2005/004847, filed Jan. 31, 2005, which claims priority to provisional patent application Ser. No. 60/540,550, filed Jan. 30, 2004, and incorporates the aforesaid patent applications in their entireties by reference thereto.

### BACKGROUND OF THE INVENTION

1. Field of the Invention

This invention relates to rotatable assemblies for a centrifuge. Particularly, this invention relates to rotatable assemblies for centrifuges for separating or treating chemical, biological, or biomedical materials in sample tubes or other containers.

2. Description of the Related Art

Centrifuges are versatile and relatively lightweight machines, which can be used for routine bench-top separation work, particularly in laboratories or physicians' offices. In general, centrifuges provide fast separation and high process rates for biomedical materials of different densities like blood or urine, by using relatively high rotational speeds and a rotatable carrier that holds sample tubes at a fixed angle (generally 45 degrees) during rotation. Often an electromechanical escapement timer is provided for a simple shutdown after a set run-time.

A common application for bench-top centrifuges is to separate blood components for various lab tests. Centrifuges have been used in the medical and pharmaceutical industries for quite some time to separate materials of different specific weights. In many cases, barrier gels are used to maintain the separation of the separated materials. Sometimes only the specific weight differences maintain the separation in a sample tube.

Conventional centrifuges usually have common structural features. In general, laboratory or bench centrifuges are mounted so that the vertically disposal drive spindle supports a rotatable assembly carrying the sample tubes. At high rpm, the spindle would be subject to vibration and flexure, with concomitant adverse resultant forces applied to the flowable sample material. Such vibration and flexure causes damage or distortion in and to the drive spindle and motor. Typically, the electric motor drive has a drive shaft or spindle that is hard mounted to an angular cone or fork-shaped rotating carrier tray that holds several sample holders.

Examples of conventional bench-top centrifuges are the CFVI line of centrifuges manufactured by Cygnus, Inc., Paterson, N.J. Each CFVI centrifuge includes a high strength, flame-retardant molded ABS plastic housing, which rests on four non-suction thermoplastic rubber feet. A shaded pole, thermally protected motor is mounted to the housing with steel reinforced braces, which provides a low and stable center of gravity for the centrifuge. A rotor head is provided that is made of high-impact ABS and is attached to the motor shaft by a spline and retaining screw. The rotor head is adapted to hold up to six tubes. The rotor head is angled, sealed, of low noise, and has low air-resistance. A high-impact clear polycarbonate, cover encloses the sealed rotor head. The centrifuge comprises a safety interlock that allows rotation of the rotor head only when the cover is closed and latched. An electronic timer linked to a motor control circuit provides timed spin cycles.

A similar related art bench top centrifuge is the Becton Dickinson ADAMS® Compact II Centrifuge that incorporates a fully adjustable hand timer and cover with operations at relatively high speeds up to 3400 rpm. This design includes an angled rotor design holding tubes at 37 degrees off the vertical. A further related art bench top centrifuge is the Horizon Mini E®, which includes a hand timer, and holds sample tubes at a 45 degree angle.

It is also known in related art centrifuges to cause the sample tube with flowable biomedical material (e.g. blood) to pivot upwardly with increasing rpm and concomitant centrifugal force. Conventional pivoting mechanism often gripped only the top portion of a sample tube, and as such do not prevent unwanted lateral jiggling. The pivot mechanism or structure often imparted ragged and jerky movements to the tube resulting in undesirable remixing and less than desired control of the material flow undergoing centrifugal forces. See FIG. 16.

Referring to FIGS. 15-18, there is shown a prior art sample tube corner of tray 400. Tray 400 is of an internal molded plastic construction. Tray 400 has a centrally disposed Mark 401 for slidably receiving vertically disposed motor or drive shaft (not shown). Tray 400 has a top annular wall 402, a peripheral contiguous outer wall 403, and an inner peripheral wall 404. A plurality of radially disposed webs 405 interconnect wall 404 with web 401. A plurality of channels 406 are formed by and disposed between the webs 405. Each channel 406 is formed by opposed planar walls 407, angularly disposed lower stop 408, and horizontally disposed upper wall or stop 409. Stop 408 is formed with a curvilinear edge 410.

In the aforesaid manner of the prior art construction, a conventional sample tube, 420 containing a specimen (not shown) is disposed in channel 406. Tube 420 centrifugally engages edge 410 in the rest position i.e. before or after centrifugation. Tube 420 is disposed at 45° in this rest position. With rotation of tray 400, tube 420 rapidly and erratically pivots from the rest position to contactingly engage wall or stop in the centrifugation 409. Tube 420 is disposed at 180° in this centrifugation position. With centrifugation, tube 420 rattles between opposed planar walls 407 in clearances 7. Consequently, the sample undergoing centrifugation is subjected to translational forces which mitigate against a clear sharp separation.

One other example of a prior art centrifuge assembly is disclosed in U.S. Pat. No. 6,835,353, to Smith et al, the contents of which are fully incorporated by reference. In Smith et al a tube assembly includes an elongated or sloped tube bottom and a cap having a pair of ports for communication with an interior portion of the tube. One of the ports is centered over the elongated tube bottom allowing sampling at the center-bottom of the sample tube post-centrifuging. This design, in a limited manner, attempts to compensate for sample remixing by allowing ready access to the likely least disturbed sample contents. A need exists in the art to minimize remixing after centrifugation.

U.S. Pat. No. 6,368,298, to Beretta et al., the contents of which are fully incorporated by reference, discloses a centrifuge is employed in a process for concentrating blood plasma for the subsequent preparation of which a autologous fibrin glue. Beretta et al., discloses a method for forming fibrin glue broadly includes the steps of separating plasma from a blood specimen, contacting the plasma with an activator and related coagulating substance, and centrifuging the plasma to form a fibrin web. A fibrin web is assistive in regenerating body tissue in a living organism, and is commonly produced in a clot small film having the diameter of the bottom of a common angle or test tube. It is important to minimize shaking or other forces effective to cause intermixing between phases separated during centrifugation. Intermixing of the separable phases reduces the effectiveness of the fibrin web system. Beretta et al. does not provide for minimizing intermixing, or for readily increasing a size of the fibrin membrane to a beneficial size or adaptive geometry, and fails in provide a system for manufacturing custom shaped fibrin membranes.

In Grippi et al., U.S. 2004/0071786 A1, the contents of which are fully incorporated by reference, there is disclosed a method for preparing a solid-fibrin web which includes a centrifuging step wherein concentric cylinders are employed to vary g-forces during operation. A concentric container is centrifuged forming a generally uniform thickness fibrin film about an circumferential inner surface. The Grippi et al. method requires separately removing the film (formed as a cylinder) by laterally slicing and pulling the formed material from the concentric container and then laying and stretching the film on a flat surface. The Grippi et al. method applies thinning and stretching forces to the film that prove a detriment to process control. A need exists in the art for providing a system that produces a readily accessible fibrin film as close to final-use form as possible to minimize product quality control concerns.

As further discussed in Grippi et al., a hydrophobic membrane is employed to substantially prevent an aqueous liquid, such as platelet-rich plasma, from flowing through its pores until a set hydrostatic pressure is reached. Examples of hydrophobic membranes include, but should not be limited to polypropylene, polycarbonate, cellulose, polyethylene, TEFLON® of Dupont and combinations thereof. Other examples of hydrophobic membranes include Millipore®. membranes and screens manufactured by Millipore, or Nucleopore®. membranes and screens manufactured by Nucleopore®. Alternatively, a plastic diaphragm having precision holes drilled therein with a laser could also be used. When using a hydrophobic membrane, blood may be introduced into a cell-separation chamber, but will not fall into a densification chamber defined via the membrane. A proper hydrostatic pressure must be achieved by first separating the red blood cells from the plasma at a low rpm. Subsequently, the rate of centrifugation is increased to achieve the desired pressure to overcome the surface energy/surface tension constraints that define the flow pressure. In other words, the gravitational force will increase with the rate of centrifugation, which will result in the platelet-rich plasma flowing through the hydrophobic membrane, but not the red blood cells. The membrane will substantially block the red blood cells.

Another modification to the above systems includes changing the configuration of a secondary or modified densification chamber as disclosed. As required in the aforesaid disclosure, the modified densification chambers may be used in systems, wherein the primary and secondary chambers have the same or different radii, wherein the chambers are concentric, and/or wherein a separating medium or hydrophobic membrane is used.

The densification chambers may have different interior walls that facilitate the removal of the membrane, and ensure the greatest recovery of the membrane, but all are cylindrical in nature.

For instance, a densification chamber may contain a woven biodegradable fabric (such as Goretex®, manufactured by Goretex) that improves the tear strength of the membrane for initial placement in the body, and that will later dissolve. The outer wall of the cylindrical chamber may also contain molded bumps or grooves that support the fabric away from the cylindrical wall at a uniform length to achieve a fibrin and platelet thickness of desired dimension on both sides of the fabric.

Typical g forces used to effect plasma cell separation may range from 200 to 15,000 g, and more commonly in the 1,000 to 10,000 g range, depending upon the geometry of the centrifuge employed, for a predetermined time, typically greater than 5 to 15 minutes. These forces are necessary to force separation for fibrin production. Grippi et al. fails to aid the production of fibrin products by either increasing volume, or decreasing processing time and limiting damaging operable vibrations, and also fails to increase production in convenient shapes and sizes for use, without employing complicated post centrifuge separation and unrolling processing steps. A need exists in the art for an improved fibrin product manufacturing system, at reduced times and in increased volumes without reducing quality. The biomedical art desired an improved system and centrifuge assembly for forming a tissue sealant web such as a fibrous web suitable for regenerating body tissue in a living organism.

Advances in the Human Genome Project have demanded innovative solutions to sample preparation in the ever changing landscape of molecular labeling and manipulation, gene mapping, gene expression, amplification, DNA sequencing and proteomics. Sample preparation has often been a bottleneck to the analysis of complex biological materials, especially in high throughput automated applications employing multiple sample sets such as genotyping and DNA sequencing.

In view of the above difficulties, solutions are needed in the centrifuge and biomedical centrifuge arts that avoid, minimize, or eliminate at least one of the aforesaid concerns or problems attendant conventional vertically disposed drive spindle supported sample tube carriers. It is also desired to provide a centrifuge having controlled tube pivot and resultant centrifugal forces particularly at high speeds. It is further desired to provide a self-containing and self-calibrating centrifuge. It is still further desired to provide a centrifuge with improved airflow characteristics. Finally, it is still further desired to provide a centrifuge that was particularly suited to treat or form alternative biological or biomedical materials in diverse configurations.

### OBJECTS AND SUMMARY OF THE INVENTION

Noting the detriments of previously known constructions, it is therefore a principal object of the present invention to provide an improved centrifuge assembly that addresses the aforesaid art desired needs and resolves at least one or more of the afore-discussed detriments and concerns.

It is a principal object of the present invention to provide a centrifuge assembly for forming a biomedical material, such as a tissue sealant web or other biomedical web.

It is another principal object of the present invention to provide a centrifuge system wherein a pivoting motion of a biomedical material sample holder is consistently smooth and uniform, to effect the desired separation.

It is another principal object of the present invention to provide a specialized housing for a biomedical material sample holder.

It is another object of the present invention to provide a centrifuge that is self-centering to compensate for both vertical and horizontal perturbations, wherein the formed webs are uniform.

It is another alternative desire of the present invention to provide a centrifuge that lowers a center of rotational gravity to improve safety and reduce unwanted vibration.

It is another object of the present invention to provide a centrifuge with improved drive characteristics.

It is another object of the present inventions to provide a centrifuge that is easily programmable, may be reprogrammed in situ, and is self-calibrating.

It is another object of the present invention to provide a centrifuge with improved airflow characteristics and a thermal management system to minimize detrimental thermal effects to the motor and specimens.

It is another object of the present invention to minimize specimen warming during use, or by introduction into an atmosphere warmed by previous repeated use.

It is another object of the present invention to provide a centrifuge that is readily adapted for diverse centrifuge methods of treatments, convenient formation of biological or biomedical materials at improved volumes, and in a variety of adaptive uses.

It is another object of the present invention to enable a production system for manufacturing biological and biomedical products, including products having optional diverse shapes and increased sizes, while minimizing post forming production steps.

It is another object of the present invention to provide a centrifuge system that has an improved design and a comprehensive electronic operation system while providing increased safety and ready adaptation across a diverse range of operational use.

The present improved centrifuge system includes a drive motor mounted independently relative to a sample carrier that minimizes detrimental forces born by a motor drive shaft. The sample tube carrier includes a rotating center operably connected to the drive motor. The drive motor cooperates with a resilient mounting system aiding self-centering, and force and vibration compensation, while improving motor life. In a selected embodiment, the sample carrier and a tube member provide respective operably cooperable contoured surfaces enabling relative smooth pivoting motion during use, minimizing sample vibration, and improving a desired sample separation while minimizing sample remixing. In another embodiment, a thermal management and airflow system minimize thermal damage and undesired thermal gradients during operation.

According to one principal embodiment, there is provided a centrifuge assembly including a rotatable carrier being formed with contoured surfaces forming circumferentially disposed orifices, wherein a sample tube holder is slidably disposed in the orifices in a first position and with rotation is smoothly movably pivotably disposed to a second position for centrifugation and separation of the material.

According to an embodiment of the present invention there is provided a centrifuge assembly, including a vertically mounted motor assembly; means for mounting said motor assembly on a first mounting assembly proximate a first distance from a support surface; a rotatable carrier assembly; means for rotatably mounting the rotatable carrier assembly on a second mounting assembly proximate a second distance from said support surface; the first distance being larger than said second distance, and means for operably connecting the motor assembly to the rotatable carrier assembly enabling a driving rotation during use, whereby the motor assembly and the rotatable carrier are independently mounted and operably connected.

The above, and other objects, features and advantages of the present invention will become apparent from the following description read in connection with the accompanying drawings, in which like reference numerals designate the same elements.

### BRIEF DESCRIPTION OF THE DRAWINGS

FIG. 1 is a front open perspective view of one embodiment of the present invention.

FIG. 1A is a front closed perspective view of the embodiment of FIG. 1.

FIG. 1B is a bottom view of the embodiment shown in FIG. 1.

FIG. 1C is a rear view of the embodiment shown in FIG. 1.

FIG. 1D is a partial side sectional view of a centrifuge assembly according to another embodiment of the present invention.

FIG. 2 is a side sectional view of the embodiment shown in FIG. 1D with an alternative housing assembly.

FIG. 3 is a first embodiment of a locking mechanism for a cover lid according to the present invention.

FIG. 4 is a cross sectional view of the embodiment of the present invention shown in FIG. 1 depicting at least a partial air flow path during operation.

FIG. 5 is a perspective view of a sample carrier and mount noting specimen holder rotation during use according to one embodiment of the present invention.

FIG. 5A is a top perspective view of a sample carrier or sample tray according to one embodiment of the present invention.

FIG. 5B is a bottom view of FIG. 5A.

FIG. 5C is a top view of FIG. 5A.

FIG. 5D is a cross-sectional view along line 5D-5D in FIG. 5C.

FIG. 5E is a perspective view of a motor housing and sample support member according to one embodiment of the present invention.

FIG. 5F is a top view of FIG. 5E.

FIG. 5G is a cross-sectional view along line 5G-5G in FIG. 5F.

FIG. 6A is a perspective view of an arrangement of a sample carrier or tray on a sample support according to one embodiment of the present invention.

FIG. 6B is another adaptive embodiment of a sample carrier or support arrangement according to another embodiment of the present invention.

FIG. 6C is another adaptive embodiment of a sample carrier or support arrangement enabling film formation within a sample holder or within a removable carrier apparatus, according to another embodiment of the present invention.

FIG. 6D is another adaptive embodiment of the present invention combining a film formation capacity with an alternative sample support capacity.

FIG. 6E is another adaptive embodiment of the present invention providing a pivoting sample capacity for centrifuging a plurality of individual pipette-type samples maintained with contained and optionally removable multiple-sample housing members while minimizing sample remixing.

FIG. 7 is a cross sectional view of a motor assembly with an adaptive drive shaft assembly and motion compensation assembly according to one embodiment of the present invention.

FIG. 7A is an expanded view of a drive shaft-housing interface, as shown in FIG. 7.

FIG. 7B is an expanded view of a motor mount assembly enabling lateral and vertical compensation, as shown in FIG. 7.

FIG. 8A is a bottom perspective view of a motor assembly according to one embodiment of the present invention.

FIG. 8B is a top perspective view of the motor assembly shown in FIG. 8A.

FIG. 9A is a top perspective view of an air rotor and support according to one embodiment of the present invention.

FIG. 9B is a bottom view of FIG. 9A depicting one embodiment of a rotational marking display.

FIG. 10 is an exploded assembly of one embodiment of the present invention including a motor cover, motor assembly and sample support.

FIG. 11 is a perspective view of an alternative electromechanical lid lock assembly according to one embodiment of the present invention.

FIG. 12 is a top perspective view of a sample holder according to one embodiment of the present invention.

FIG. 12A is a cross-sectional view along line 12A-12A as the assembly in FIG. 12 including an additional sample tube and cap.

FIG. 12B is a cross-sectional view of an alternative embodiment of a sample holder providing a flat bottom for adaptive centrifugation.

FIG. 12C is a sectional view of the sample tube holder assembly as shown in FIG. 12A showing the centrifuged fractions of the sample material.

FIG. 12D is a sectional view of the sample tube of FIG. 12B showing the centrifuged fractions of the sample material.

FIGS. 13-13D is an illustrative power supply layout according to one suggested and alternative embodiment of the present invention linking a lid lock circuit, a motor control circuit, and an initial power supply circuit.

FIGS. 14-14D is an illustrative assembly of various control circuits for an input/display/control assembly according to an alternative embodiment of the present invention, wherein the assembly depicts illustrative assemblies of various microprocessor controls, their circuits, and displays.

FIG. 15 is a top perspective view of a prior art assembly.

FIG. 16 is a top plan view of the prior art rotatable carrier assembly of FIG. 15.

FIG. 17 is a sectional view taken along line 17-17 of FIG. 16.

FIG. 18 is a partial vertical view taken along line 18-18 of FIG. 17.

### DETAILED DESCRIPTION OF THE PREFERRED EMBODIMENTS

Reference will now be made in detail to several embodiments of the invention that are illustrated in the accompanying drawings. Wherever possible, the same or similar reference numerals are used in the drawings and the description to refer to the same or like parts or steps. The drawings are to be understood as being in simplified form and are not to a precise scale or perspective.

For purposes of convenience and clarity only, directional terms, such as top, bottom, up, down, over, above, and below may be used with respect to the drawings. Similarly, directional markings including arrows or dashed alternative position lines may depict motion or action. These and similar directional terms and indicators should not be construed to limit the scope of the invention in any manner. The words “connect,” “couple,” “support,” and similar terms with their inflectional morphemes do not necessarily denote direct and immediate connections, but also include connections through mediate elements or devices.

One embodiment of the present invention is a centrifuge system having a motor that is independently mounted from the rotatable carrier or assembly or motor cover. The rotating assembly includes its own independent rotating center, and its own bearing independent from the motors and separates the motor from a surrounding chamber. The drive shaft or spindle does not bear the weight of the rotatable assembly and functions to substantially lower a center of gravity. The rotatable assembly comprises its own independent rotating center, preferably with a ball bearing assembly. The rotatable assembly is connected to the motor by a flexible coupling assembly, which allows easy changes between a wide variety of motor selections and sample tube holders for the different centrifugation tasks without necessitating a change in other parts of the device.

The flexible coupling assembly also extends the lifetime of the motor and its bearings and enables a reduction in standard motor size for a speed due to the weight-bearing reduction. The motor is positioned on a pedestal assembly or motor holding assembly, which includes a wave spring which bears the weight of the drive motor while allowing adaptive flexibility during use, as will be further discussed hereinafter. The pedestal assembly or motor holding assembly serves several functions, including; supporting the motor, providing a rotational center (i.e., a ball bearing) to carry an independent rotatable carrier assembly, and integrate an impeller mechanism for providing a beneficial airflow to cool the motor and enhance a thermal management system capable of transporting warmed air away from the motor and specimens to minimize thermal impact.

The centrifuge motor is mounted on the pedestal assembly in a way that allows the motor assembly to self-align so the independent motor cover bearing and the motor shaft align themselves during use.

An additional benefit to the present invention is a substantially lowered center of gravity. In conventional designs, sample trays or holders were positioned at the top of a drive motor. In the present design, the rotatable carrier assembly ensures that specimen holding units are substantially below the top of the drive motor, often at a bottom one-third of the drive motor. As a consequence, the present invention provides a substantially lowered center of gravity and, in turn, this increases safety, minimizes vibration, and reduces motor stress.

Aspects of the present invention also provide an adaptive housing assembly that enhances many functions, including; providing a cover for the rotatable carrier assembly to control or minimize undesirable air resistance and providing improved thermal management while simultaneously improving operator safety.

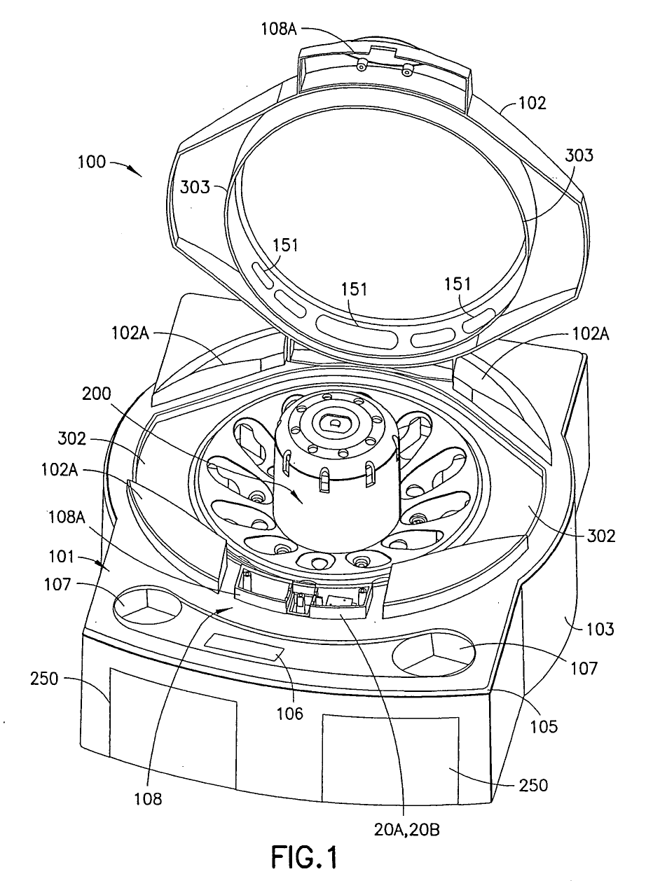

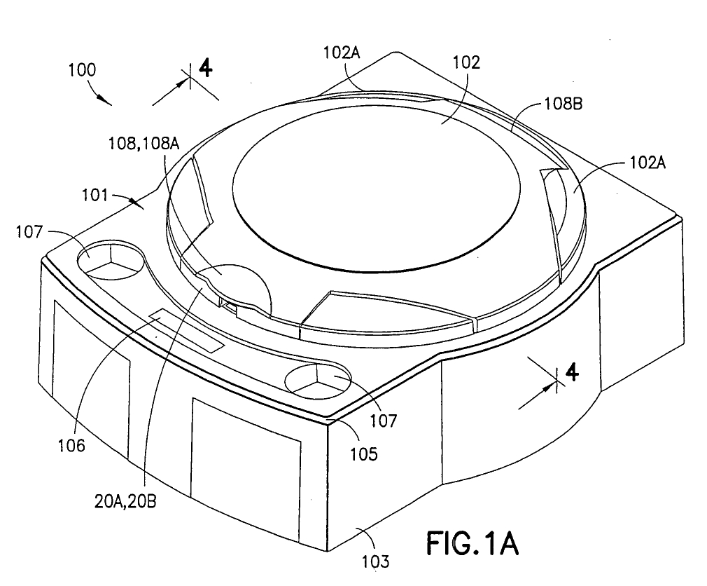

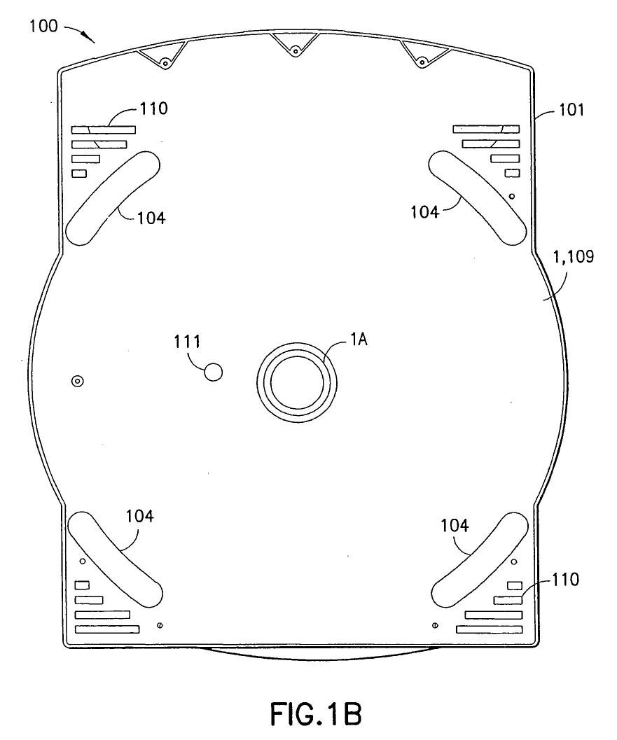

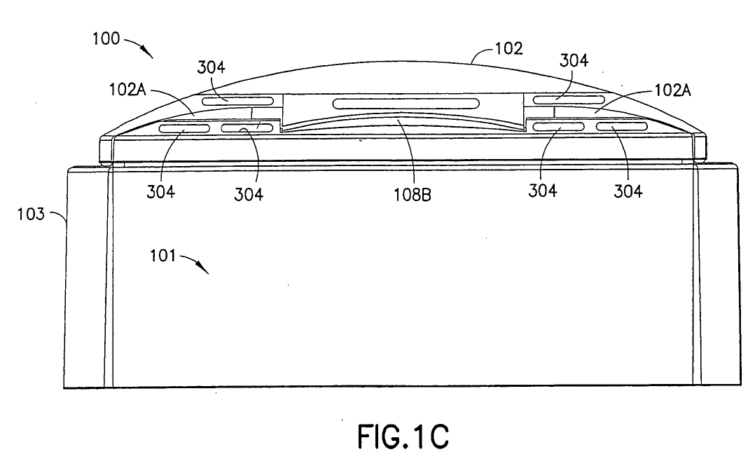

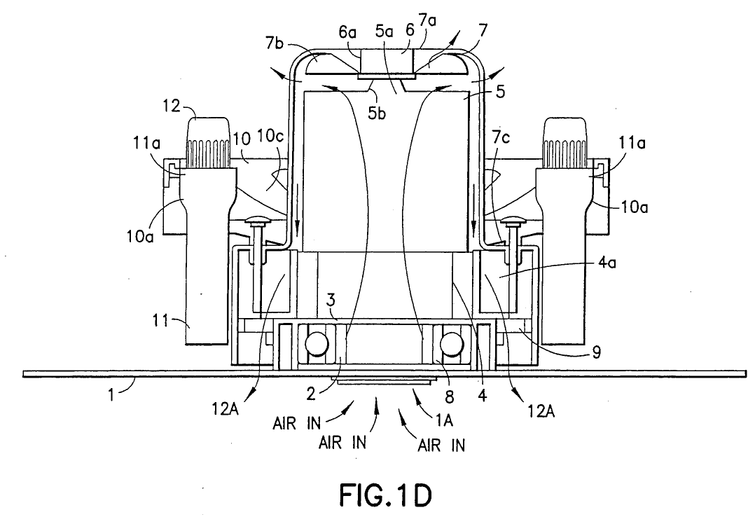

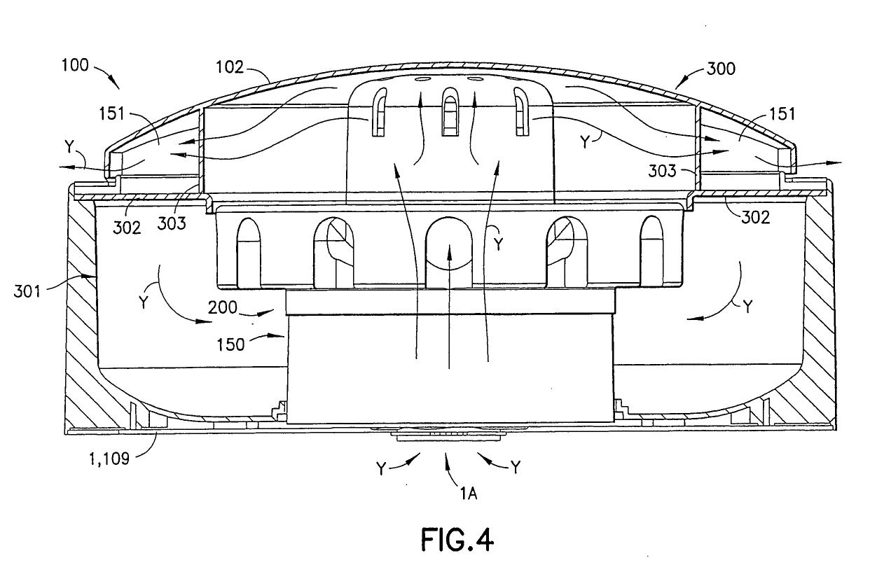

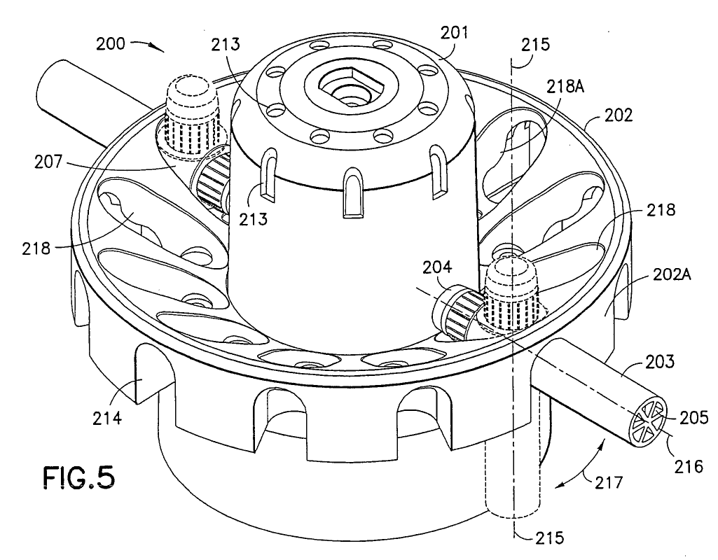

Referring now to FIGS. 1, 1A, 1B, 1C, and 4, in one embodiment of the present invention a centrifuge assembly 100 combines a plurality of subassemblies including at least a housing assembly 101, a motor assembly 150, a rotatable carrier assembly 200, and an electronics assembly 250.

Electronics assembly 250 has no particular design or casing and is visually represented by reference numerals 250 in FIG. 1, but may be positioned anywhere within centrifuge assembly 100 according to a manufacturer's design and component requirements. The electronics assembly 250 is equipped with electronics that provide digital readout, time setting, rpm indication and others. The electronics assembly 250 is also equipped with electronic rpm control for AC and DC type motors, an unbalance indication, an emergency stop circuit, a total cycle count indicator, and a self-calibrating feature.

Housing assembly 101 includes a lid or cover assembly 102 pivotably joined to a base assembly 103 spaced from a supporting surface (not shown) by a plurality of supporting leg members 104. Housing assembly 101 serves to operably contain, and support the entire centrifuge assembly 100, as will be described.

Base assembly 103 includes a front portion 105 with a display unit 106 operating as one of an analog and a digital display unit. In preferred embodiments, display unit 106 may be a digital LCD (Liquid Crystal Display) or LED (Light Emitting Diode) display, or a combination of both depending upon a manufacturer's preference. Digital displays are preferred with the present embodiment of electronics assembly 250 as being easily interfaced with the incorporated electronic assembly 250, but nothing herein shall prevent the use of analog displays in concert with controlling electronics.

Those skilled in the art of circuit and electronic equipment design will recognize that additional display areas may be provided on base assembly 103, and even on cover assembly 102, depending upon a manufacturer's desire without departing from the scope of the present discussion.

Process control input regions 107 allow an easy touch-interface with electronics assembly 250 contained within housing assembly 101, as will be described. As shown, input regions 107 allow operation of preferably a speed/time increase, a speed/time decrease, on/off, timer set, lock and unlock functions, and many others as may be suggested by a manufacturer.

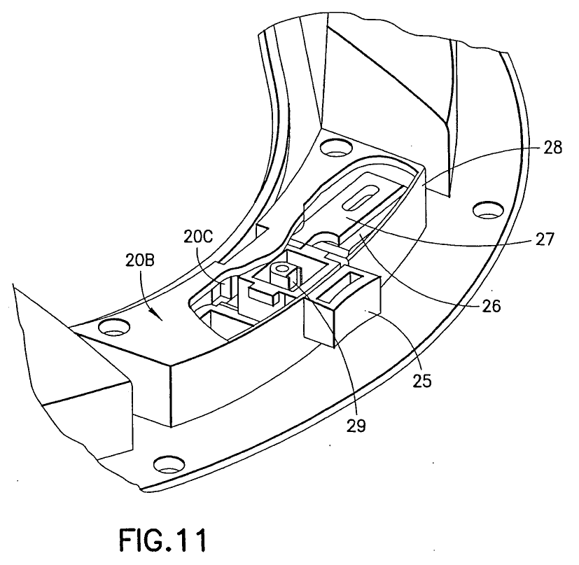

Housing assembly 101 includes an optional cover locking and release assembly 108 including electromechanical locking and release mechanisms 20A (FIG. 3), 20B (FIG. 11), cover latch mechanism 108A, and hinge assembly 108B.

As will be described below, cover locking and release assembly 108 includes a cover-position sensor (not shown), enabling electronics assembly 250 to determine whether or not cover assembly 102 is secured to base assembly 103. As will also be described, cover locking and release assembly 108 includes a capacity to securely lock cover 102 to base assembly 103 during use for increased safety, and to prevent opening while motor assembly 150 is spinning.

Cover assembly 102 and base assembly 103 of housing assembly 101 may be constructed from any suitable material including metals and plastics or combinations of the same. In one preferred embodiment, cover assembly 102 and base assembly 103 are constructed from high strength non-metals including plastic, nylon, acrylic or other materials useful in forming a strong, tough, and reasonably light body. Since centrifuge assembly 100 operates at high speeds, RPM's as high as 3700, housing assembly 101 should be constructed to contain debris during equipment breakdowns and protect operators.

Bottom base plates 1, 109 are provided for supporting housing assembly 101, and is typically constructed from metal for rigidity, strength, and durability. Base plates 1, 109, while preferably constructed from metal may alternatively be constructed from any suitable material. Base plates 1, 109 are securely joined with base assembly 103 and serve to contain the internal assemblies during use and transport.

Base plates 1, 109 may include vent openings 110 to ensure electronics assembly 250 and the other assemblies are able to remain cool during operation. Optionally, a vent fan (not shown), may pierce housing assembly 101 to flush warm air during repeated use to improve quality control by keeping electronics assembly 250 cool, minimize thermal variability, and minimize thermal strain on all the internal components. In another embodiment, base plates 1, 109 may be pressure-sealed with housing assembly 101, enabling the use of a selected partial pressure atmosphere (Ag, N2, etc.) within centrifuge assembly 100 to support selected experimental uses.

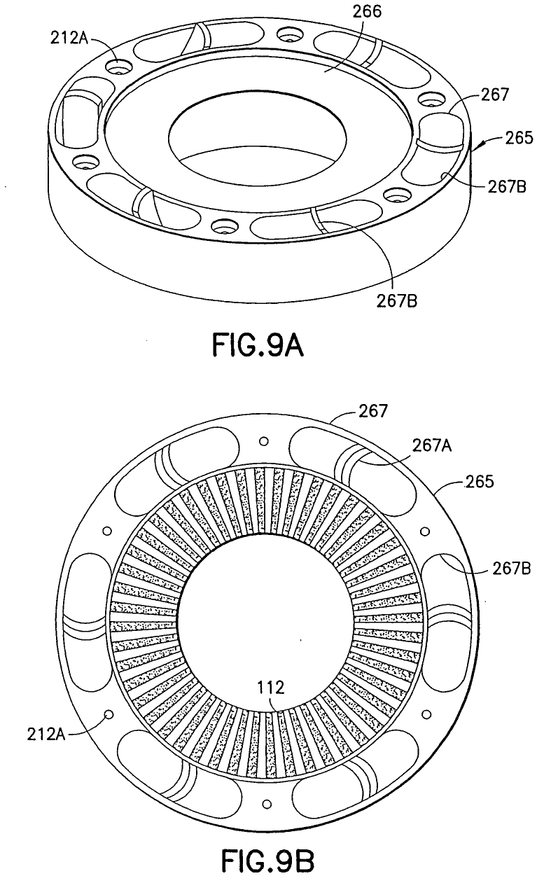

As will be discussed more fully below, the present embodiment provides a hollow tube with a ventilation aperture 1A that pierces base plates 1, 109 proximate a center of centrifuge assembly 100. A speed or rotation sensor 111 is positioned in base plates 1, 109 proximate a pattern or image 112 display (see FIG. 9B) to enable rpm sensing during use, as will be described.

Housing assembly 101 and centrifuge assembly 100 also contain a thermal management and air moving system, shown generally at 300 for cooling motor assembly 150 during use, and limiting sample thermal buildup during operation, as will be described. Thermal management system 300 includes a chamber member 301 defining a bounded region within housing assembly 101 for separating motor assembly 150 and rotatable carrier assembly 200 from the remaining interior area of housing assembly 101, as shown best in FIG. 4.

As best seen in FIGS. 1 and 4, an air shield 302 covers a top portion of chamber member 301, is in a closely spaced position with an outer surface of a portion of rotatable carrier assembly 200, and functions to operably separate chamber member 301 from an external atmosphere during operation. Air shield 302 is removable for easy replacement and simple access to chamber member 301.

During operation, when lid or cover assembly 102 is closed, a sealing lip 303 contacts portions of air shield 302 and serves to minimize air disturbance of rotatable carrier assembly 200 during use while aiding air and thermal management system 300. As shown, one or more cover stabilizers and air sealers 102A serve to stabilize cover assembly 102 in a lid-closed position. Select ones of cover stabilizers and air stabilizers 102A are positioned proximate hinge assembly 108 and aid-cooling airflow, as will be described.

During operation, thermal management system 300 enables air flow represented by arrows Y in FIG. 4, to develop as air is drawn in through ventilation aperture 1A, passed through motor assembly 150 (as will be described) and through a plurality of air movement channels and openings 151 formed in an inner region of lid 102 proximate sealing lip 303. Air movement channels and openings 151 are in open communication with a plurality of rear air openings 304, formed in a rear portion of cover assembly 102 and in select rear ones of the plurality of cover stabilizers and air stabilizers 102A. In this manner, air flow arrows Y develop from bottom ventilation aperture 1A, serve to cool motor assembly 150 (as will be discussed), and ultimately exit the rear of housing assembly 101 via air openings 304 without detrimentally interfering with specimen holders, as will be described.

One particular benefit of the present design is that thermal management system 300, in concert with air chamber member 301, air shield 302, and cover assembly 102, and other elements noted herein, serves to continuously introduce and distribute new cooling air via ventilation aperture 1A and evacuate warmed air at a rear of the unit.

This system enables convenient thermal maintenance of motor assembly 150 while substantially minimizing interfering air currents under cover assembly 102 during use. By both minimizing perturbing air currents and providing simple thermal maintenance, the operable life of centrifuge assembly 100 is greatly improved, less strain is placed on motor assembly 150, and unit vibration is minimized improving sample quality and sample separation.

One additional benefit provided by the present design, and the use of thermal management system 300 is that centrifugation specimens are subject to a lower thermal gradient. Thermal management system 300, and air shield 302 serve to substantially thermally separate a bottom (specimen region) of a sample tube (shown later) from a top portion of the sample tube/tube holder retained within rotatable carrier assembly 200. As will be understood by those skilled in the art, most specimens undergoing centrifugation are at a bottom of a specimen tube (to be introduced) and positioned within air chamber member 301 (below air shield 302), while the tops of the specimen tubes are retained below cover assembly 102 proximate air shield 302 (best sheen in FIG. 4) within the path of the now warmed air flow from motor assembly 150. As a consequence, the actual specimens are consistently maintained in a cooler operating region.

Those skilled in the art will understand that the present design for thermal management system 300 separates the now-warmed-cooling air (after cooling motor assembly 150) from the atmosphere surrounding the ends of the specimen tubes/tube holder within air chamber 301. As a further consequence of the present design, each specimen is exposed to a substantially reduced thermal gradient, enabling an increased quality control and minimizing sample variation between individual runs. As a result, the present design manages air movement and provides a thermal management system to minimize detrimental thermal variability.

It should be understood, that at high rpm, the un-shielded air within conventional centrifuges frequently cavitates and causes substantial vibration. With the present air management system 300 and structural design in mind, those skilled in the art will recognize that the air within chamber 301 (a defined air spinning chamber) shown by arrows Z is perturbed only by the specimen holders/sample tubes (described later), and not by external airflow or cross currents. This allows the ready development of a semi-laminar or a laminar airflow within chamber 301 during use; further minimizing specimen exposure to vibration and thermal gradient

It should be additionally understood, that additional air maintenance systems may be employed in combination with the present invention. These additional systems optionally include an air-pressure reduction system to reduce the atmospheric pressure within chamber 301 or under cover assembly 102 via an evacuation or vacuum system. The present invention may also be adapted to include an air maintenance system that also includes the use of cooled air transferred under pressure through ventilation aperture 1A to increase a cooling effect. These additional systems may also be adapted to supply a selected gas or gas combination to chamber member 301 during use to preserve a desired specimen atmosphere.

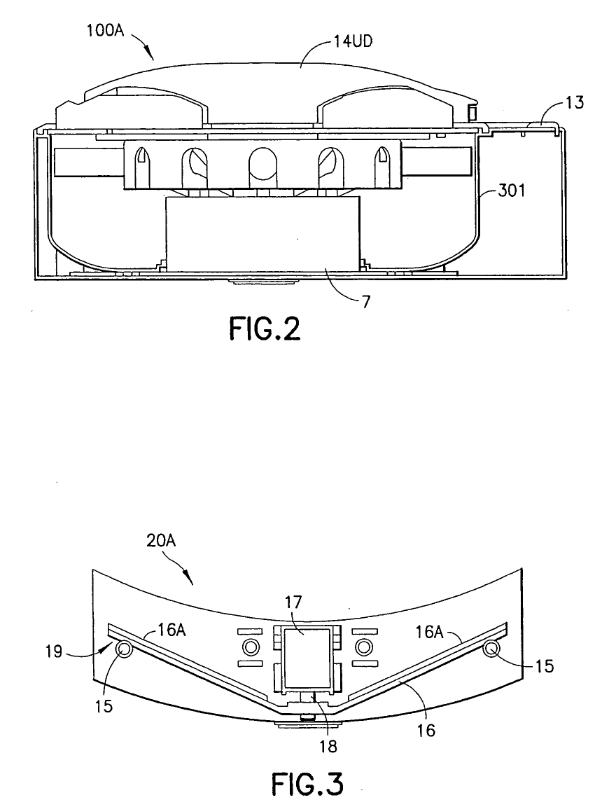

Referring additionally to FIGS. 1D, 2, and 3, there is shown one alternative motor and rotatable carrier assembly according to one aspect of the present invention. In this embodiment, an alternative centrifuge assembly 100A includes a drive motor assembly 5 disposed on a pedestal assembly comprising base plate 1, and is spaced apart from a motor plate 3 by a vertically-extending shaft member 2. Between motor assembly 5 and motor plate 3 is a vertically extending shift-able/flexible mounting element 4. A lid 14 covers centrifuge housing 14 and covers motor housing 7 and chamber member 301.

Motor assembly 5 is seated directly on flexible mounting element 4. As noted above, ventilation aperture 1a is defined through base plate 1, shaft member 2, motor plate 3, and flexible mounting element 4. As described in further detail below, motor assembly 5 is constructed so that cooling air may enter through vents in its underside, driven by a supporting impeller mechanism 12A and exit through vents in its topside.

Motor assembly 5 include may be any suitable motor. Preferably, for rotational speeds less than about 3500 to 3800 rpm, motor 5 is an A/C motor. Suitable A/C motors include asynchronous motors, synchronous motors, and shaded-pole motors. Alternatively, for rotational speeds of more than about 3500 to 3800 rpm, motor 5 is preferably a D/C/motor, which can be traditional or brushless.

A motor shaft 5a holds a flexible driving element 6, which is preferably a hexagonally-shaped block or nut. The flexible driving element 6 is connected to a rotatable carrier assembly, which comprises a motor housing 7 and a replaceable sample tray 10.

Motor assembly 5, motor shaft 5a, and flexible driving element 6 are disposed within housing 7. Space is provided between an inner surface of housing 7 and an outer surface of a motor to allow for airflow, as described in greater detail herein below. As illustrated in FIG. 1D, housing 7 comprises an upper portion having an opening 7a adapted to receive flexible driving element 6. Flexible driving element 6 preferably includes a shoulder 6a that is wider than opening 7a so that flexible driving element 6 is prevented from passing completely through opening 7a. In other words, housing 7 rests on the upper surface of shoulder 6a.

To prevent motor 5 from rising off flexible mounting element 4 during operation, motor shaft 5a comprises a ledge 5b that abuts the lower surface of shoulder 6a. The weight of motor housing 7 is thusly transferred through shoulder 6a onto ledge 5b. Significantly, using the arrangement shown in FIG. 1D, motor 5 is held in place during operation between flexible mounting element 4 and flexible driving element 6 without any additional mounting provision, such as screws, nuts, etc. Moreover, flexible mounting element 4 and flexible driving element 6 effectively suspended motor 5 so that vibrations created by motor 5 during its operation are not transmitted to motor housing 7. This improves motor life and specimen quality control. In this alternative embodiment, flexible mounting element 4 and flexible driving element 6 are preferably made of a flexible material (e.g., rubber), which can be natural or synthetic. Preferably, the flexible rubber used to make flexible mounting element 4 and flexible driving element 6 has a hardness of about 70 to about 80 shore.

As noted, motor cover or housing 7 may be made of any suitable material by any suitable method. One preferred material for housing 7 is ABS plastic. A preferred method for making housing 7 is injection molding. In another embodiment, housing 7 may be formed from a metal.

Motor cover assembly or motor cover housing 7 includes a lower portion, the inner surface of which is connected to an inwardly-extending air connecting plate 9. A connecting plate 9 comprises an inner edge that is supported on a rotatable bearing assembly 8, which is preferably a ball bearing. Rotatable bearing assembly 8 surrounds shaft 2. Thus, the lower portion of housing 7 is supported by rotatable bearing assembly 8, and motor 7 is substantially completely enclosed within removable housing 7.

The size (i.e., the diameter) of bearing assembly 8 is determined by the size of shaft 2, which is primarily determined by a desired airflow required by motor 5. To maximize the potential airflow to motor 5, bearing assembly 8 is preferably a high-strength, large diameter ball bearing, even though housing 7 is relatively lightweight.

Airflow within housing assembly or motor cover 7 is required to cool motor 5 during operation of the centrifuge. The inner surface of the upper portion of housing 7 is provided with a plurality of fixed vanes 7b, which create airflow within housing 7 when housing 7 is rotated by motor 5.

Preferably, housing 7 comprises six vanes 7b, but any number of vanes may be provided on housing 7 or along the surfaces of housing 7. Upon rotation of housing 7, air initially within housing 7 is forced by vanes 7b through the space between housing 7 and motor 5. The flowing air passes out of housing 7 through vents provided in connecting plate 9. Concurrently, fresh air is pulled into motor 5 through shaft 2. Therefore, rotation of housing 7 provides an airflow that comes up into shaft 2, up through motor 5, down between housing 7 and motor 5, and finally out through connecting plate 9.

In addition, to further enhance air flow within housing 7, flexible mounting element 4 may comprise a plurality of substantially vertical ribs 4a of impeller mechanism 12A adapted to create a laminar flow of air that encourages air to exit housing 7. The amount of airflow required by motor 5 depends on factors well known to those skilled in the art, such as the type and size of the motor, the required rotational speed, and the weight of the rotational carrier.

In the present embodiment, a carrier tray assembly 10 is removably attached to motor housing cover 7 at its inner portion 10c to a medial shoulder portion 7c of housing 7.

Tray 10 is adapted to receive a plurality of sample holders 11 having optional caps 12. Tray 10 comprises a plurality of hollowed or downwardly radially rounded receptacles 10a adapted to hold a respective number of elongated sample tube holders 11. A sample tube holder 11 adapted for use with tray 10 comprises a flared neck portion 11a having an outwardly rounded shape matching the downwardly rounded shape of rounded receptacles 10a. Thusly, a sample tube holder 11 may freely pivot (cooperatively pivot) within tray 10, such that sample tube holder 11 will be substantially vertical before and after rotational operation of the centrifuge and substantially horizontal during rotation operation of the centrifuge, with smoothly pivoting operation there between. This present design may be referred to as a system or mechanism for cooperatively pivoting or smoothly pivoting a sample tube or sample tube holder relative to a sample holding tray.

Preferably, each sample tube holder 11 comprises a flat bottom surface so as to be able to stand on its own, and protective cap 12 prevents air exposure of the sample if the sample tube therein is broken or if the specimen somehow climes the walls of the tube during centrifugation.

As noted, cooperatively rounded receptacles 10a and sample tube holders 11 may be color coded for ease of use. For example, in order to facilitate quick and proper balancing of the centrifuge, opposing pairs of receptacles may be coded with the same color (or other indicia, not shown) so that a user can easily identify each opposing pair of receptacles. Accordingly, the user will not have to count the number of receptacles and/or calculate which are the opposing receptacles. The user would simply place a sample tube holder in each of the same-colored (same indicia) receptacles, knowing that same-colored receptacles are opposing receptacles. This technique speeds operation and minimizes human error.

In the present embodiment centrifuge assembly 100A includes centrifuge housing 13, which allows the rotatable carrier to rotate with a minimum of air friction. Housing 13 has a lid 14 adapted to provide access to the centrifuge assembly, while also preventing additional air entry to the chamber during rotational operation of the device.

Recognizing that human error exists, and that centrifugation forces are substantial, lid 14 preferably engages an electromechanical locking mechanism 20A to secure lid 14 during the centrifugation process. A preferred locking mechanism for use in the present invention comprises two pins 15, each having a recess or groove 19. The respective grooves 19 of the respective pins 15 receive respective tines of a locking fork 16 when lid 14 is in a closed position. Preferably, pins 15 are mounted in housing 13, and locking fork 16 is mounted in lid 14.

A spring 18 resiliently urges locking fork 16 into the grooves 19. When the centrifuge process is completed a solenoid 17 pulls locking fork 16 from grooves 19, thereby releasing lid 14. Those skilled in the art should recognized that solenoid 17 may be substituted with a manual releasing knob (not shown), either one being optionally interfaced with a variety of automatic motor breaking systems upon electronic notice of a lid-open condition, to minimize operator injury. The present system includes an electronic breaking system, not shown, capable of stopping rotating motion within approximately 20 seconds for improved user safety.

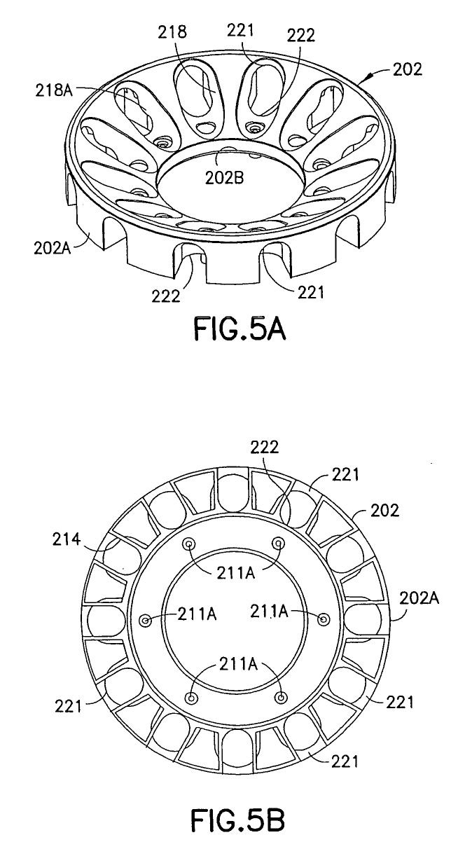

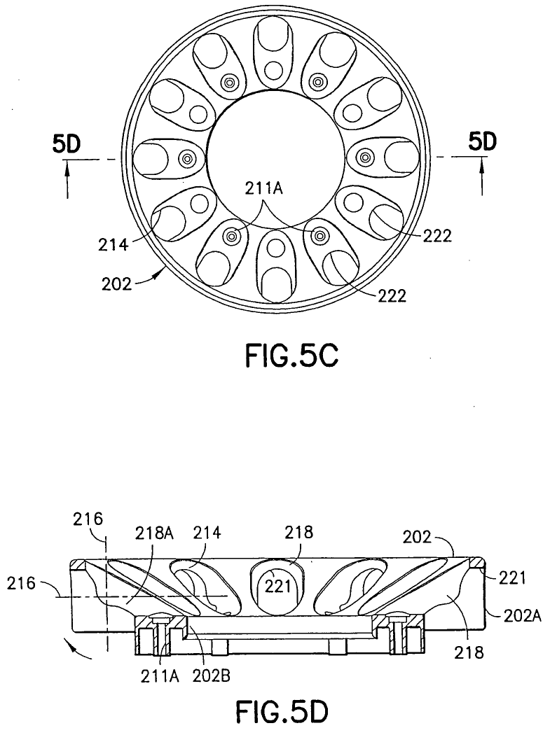

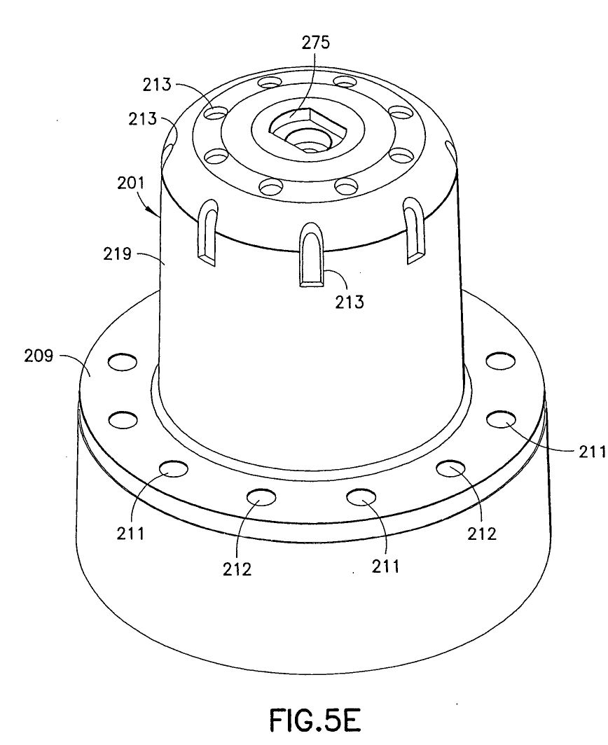

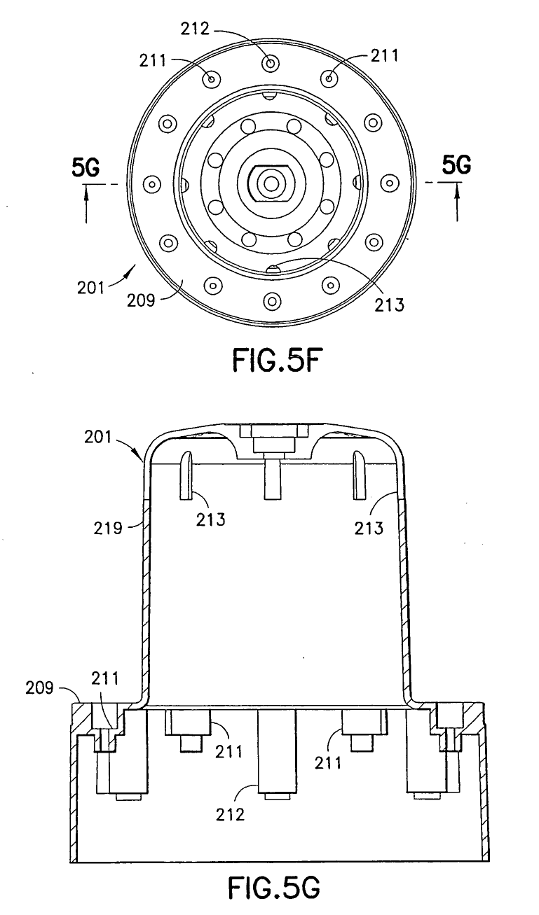

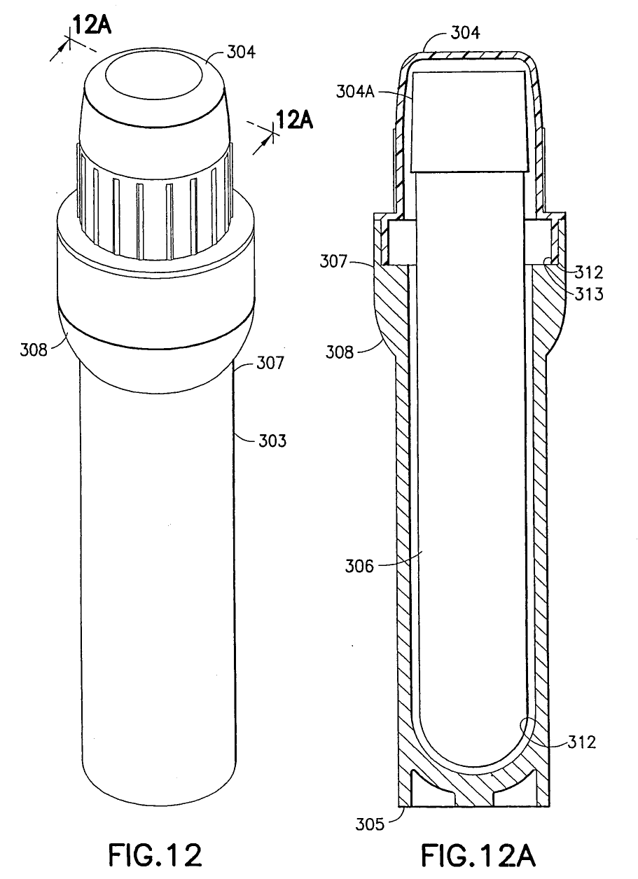

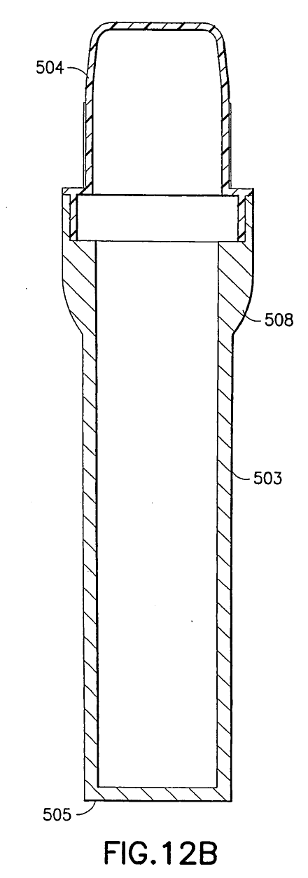

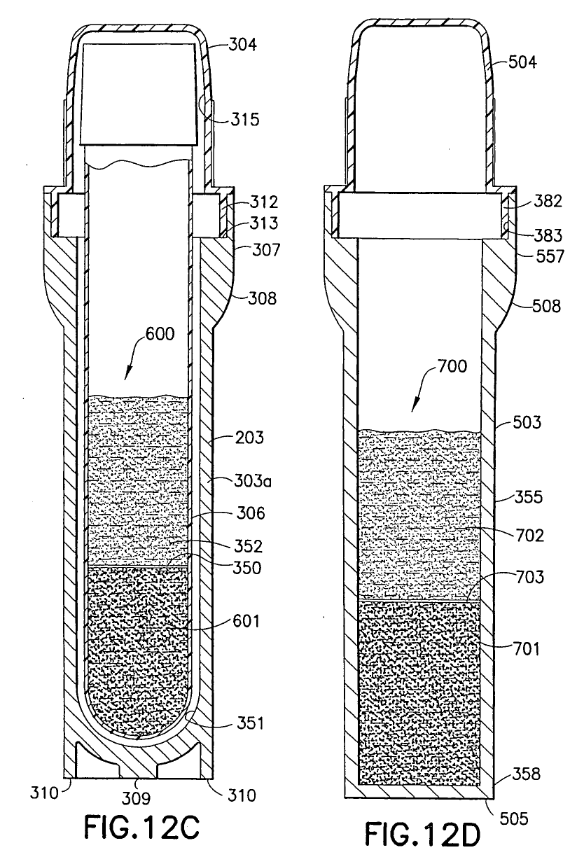

Referring now to FIGS. 5 through 5G, and more specifically FIGS. 12A to 12C, rotatable carrier assembly 200 includes a motor cover or motor housing cover 201 (covering motor assembly 150), and a tube sample holding unit or tray 202 of interchangeable design. Sample holding unit or tray 202 includes a plurality of openings 210 for pivotably receiving respective sample tube holder or assembly 203 having removable caps 304 for holding a sample tube 306 (as best shown in FIG. 12A). Sample tube 306 has a replaceable and removable cap 304A. Holder assembly 303 has an external planar bottom support surface 305.

As noted, flat bottom surface 305 allows sample tube holder 203 to stand upright on a surface for easy use and transport. When a sample tube 306 includes a conventional rounded bottom, tube holder 303 may have a corresponding interior rounded bottom to distribute force equally during centrifugation.

In an optional embodiment, sample tube holder 503 may themselves be employed to hold specimens, as noted in FIG. 12B. In this embodiment, an inner bottom surface of sample tube 503 is also flat or perpendicular to the long axis of the sample tube holder. As a consequence, small volumes of material may be centrifuged allowing segregation by mass with no remixing as will be discussed. Since the flat bottom provides a uniform support surface, small samples experience uniform separation. Since sample tube holder 503 has a flat bottom and stands upright, no separate support is needed, and a user may pipette a small sample from a bottom of the tube without remixing concern.

Referring specifically to FIGS. 12C and 12D, there are shown further embodiments, sample tube holders 203 and 503, respectively. Sample tube holder 203 includes a cylindrical body 303A having a radially outwardly extending shoulder 308, which forms cylindrical body portion 307. The bottom 305 is formed with a centrally disposed planar foot or portion 309 and an annularly disposed planar foot or portion 310. Planar portions 309 and 310 are formed so that holder 203 can set upright on a work surface. A cap 304 is formed with annular leg 312 to be removably received in body recess or lip 313. The inside surface 314 of body 305 and the inside surface 315 of cap 312 are formed to receive sample tube 306 with cap 304A. Orifice 210 is formed with a first contoured (concave) surface 411, a second contoured (convex) transition surface 412, and a third, contoured (concave) surface 413. In this manner of construction, sample tube holder 203 with the sample tube therein may be removably received in a first contoured orifice 411 of the rotable tray or assembly for centrifugation. FIG. 12C depicts the sample tube and sample tube holder after centrifugation of the sample. After centrifugation, the sample 600 is separated by membrane 350 into concentrated or dense fraction 351 and diluted or light fraction 352.

Referring now specifically to FIG. 12D, there is shown sample tube 503. Sample tube or holder 503 functions as its own sample tube. Sample tube holder 503 is formed with cylindrical body 355 having radially outwardly extending shoulder 508 forming outer cylindrical portion 557. Bottom 358 is formed with planar surface 505 to permit tube 503 to stand upright on a work surface. A removable cap 504 is formed with annular leg 382 to be received in ledge or lip 383. The inside surface 354 of body 355 is formed to receive sample material for centrifugation. As shown in FIG. 12D, the sample material 700 has undergone centrifugation, so that membrane 703 separates dense material 701 from light material 702.

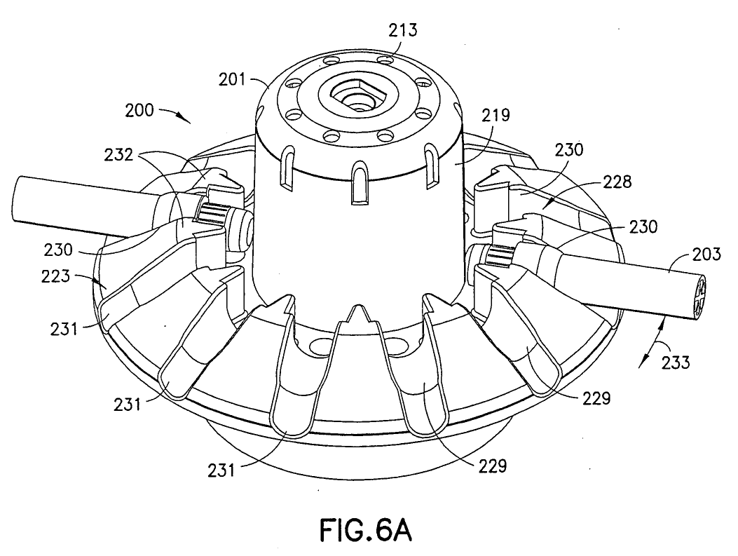

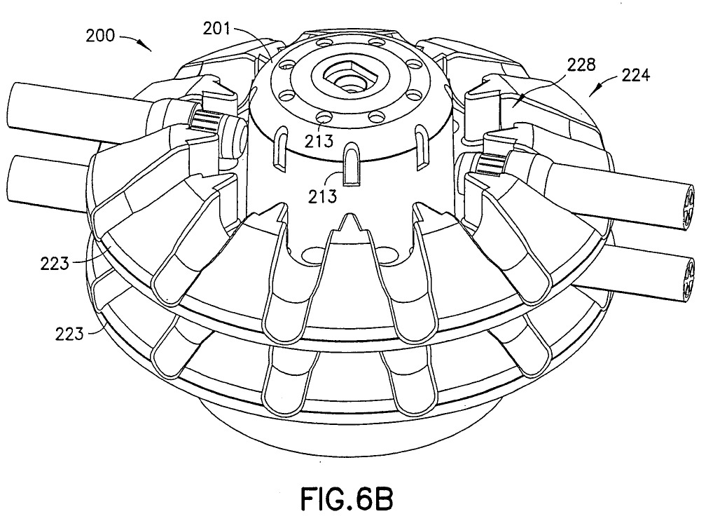

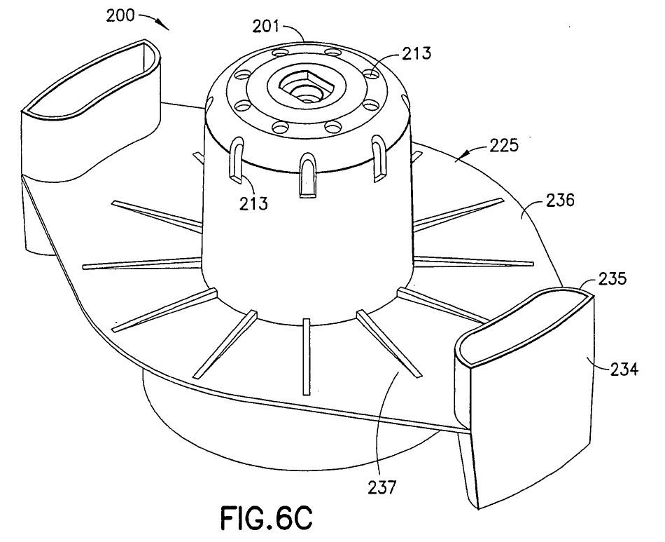

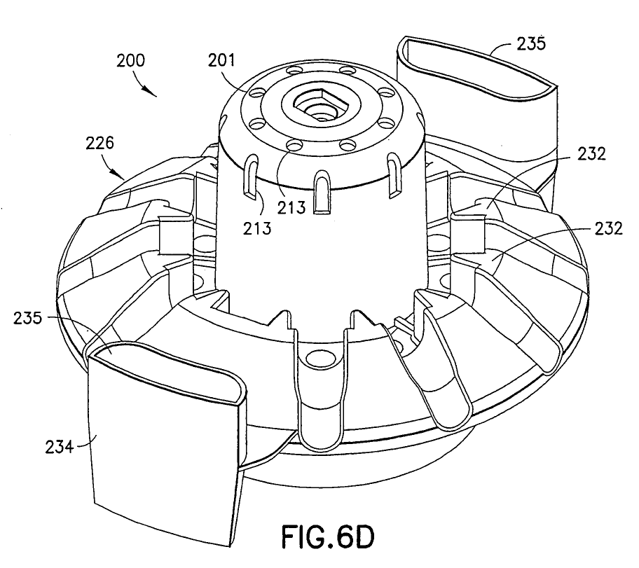

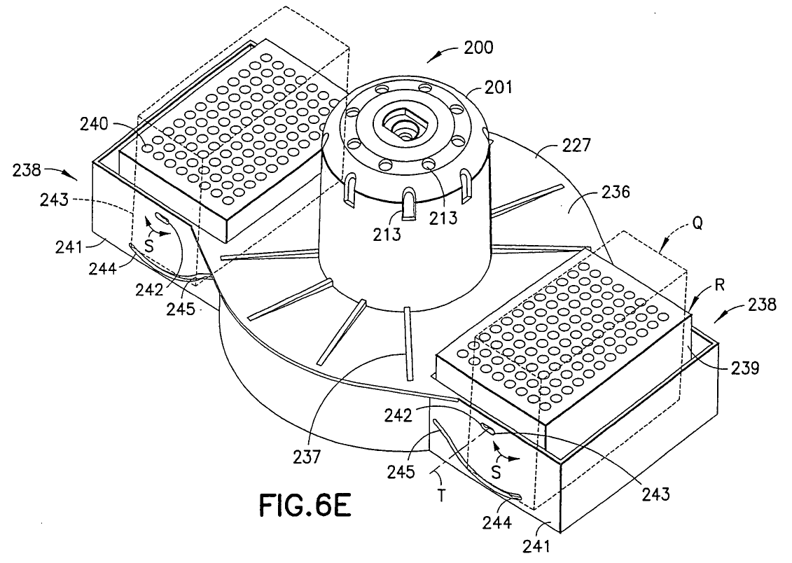

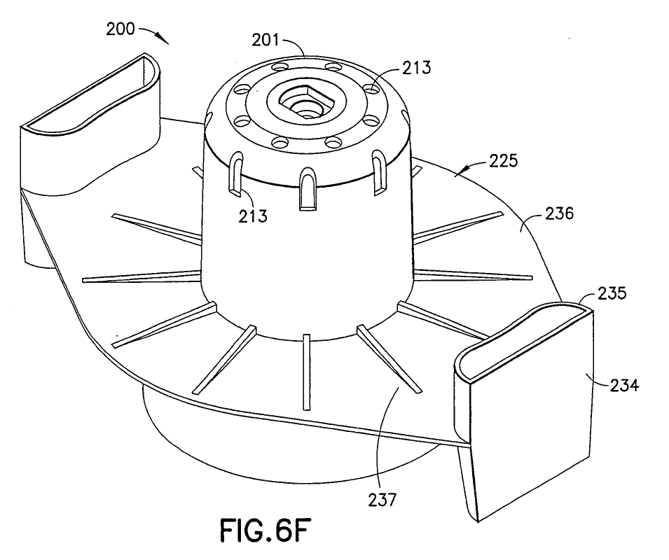

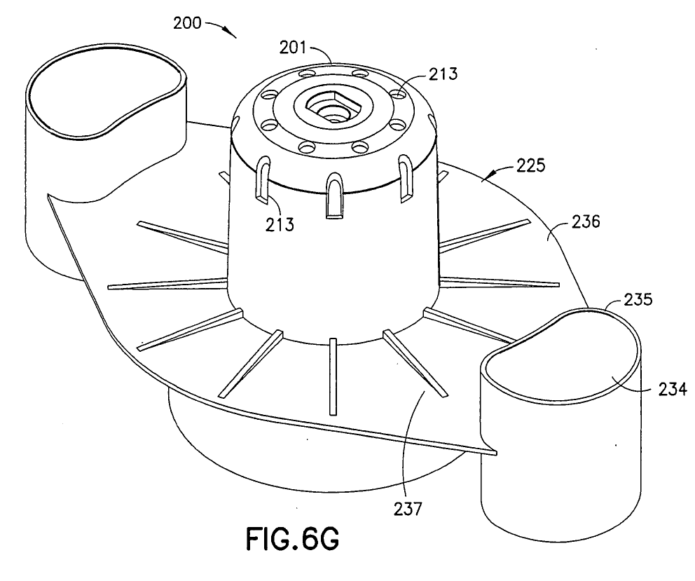

Sample tube holder or assembly 303 is shown in FIGS. 5 and 6A. Sample tube holder 303 has an axis or center line 215. In this manner of construction, the shoulder rests in first contoured surface 411 of orifice 210 in rotatable assembly 200 prior to rotation (i.e. the rest position). The carrier radius 216 and tube axis 215 subtend an angle of about 90° in this rest position. With rotation of carrier 210, holder shoulder 356 rides smoothly upwardly through angle 217 across second contoured surface 412 into contact with third contoured surface 413. At the extreme movement, the carrier radius and tube axis subtend an angle approaching 180°.

Sample holding unit or tray 202 rests on a lower portion 209 of motor cover or motor housing cover 201, and is easily and removably joined to the same via a plurality of joining threaded receptacles 211 by respective bolts (not shown). Threaded receptacles 211 formed in lower portion 209 are interspaced with openings 212 for removably fixing rotatable carrier assembly 200 to a bearing assembly as will be described (shown later). Sample holding unit 202 includes openings 211A corresponding to threaded receptacles 211. An upper portion 219 of motor cover or motor housing cover 210 protects and covers motor assembly 150 while enabling a smooth air-cooling path during operation, as will be described.

Motor cover or motor housing cover 201 includes a plurality of venting openings 213 for removing warmed thermal air from an inside of motor housing cover 201 proximate motor assembly 150.

Sample holding unit or tray 202 of rotatable assembly 200 includes a plurality of openings 210 for receiving respective sample tube holders 203. An outer perimeter 202A, of sample holding unit 202, is cylindraceous and is in close proximity with an inner edge surface of air shield 302 as shown in FIG. 1. Outer perimeter 202A has a greater thickness than an inner perimeter 202B of sample holding unit.

Openings or orifices 210 provide geometries denoting respective first vertical axis 215 openings coincident with a vertical axis of respective sample tube holder 203 vertically positioned within openings 210 in a non-centrifugation stopped condition. Openings 210 have a second horizontal axis 216 coincident with the axis of sample tube holder 203 in a horizontal position in the run position. During operation, sample tube holders 203 operably pivots from the vertical position to the horizontal position through an arc 217, under the centrifugal forces applied by motor assembly 150. Openings 210 include a continuous smooth pivoting transition surface 412 between each axis 215, 216 position. The radius of opening 210, perpendicular to either axis 215, 216, is the proximate diameter of sample tube holder 203 to prevent tube holder 203 from passing through opening 210 and away from the rotational center. Transition surface 412 has a centrally located contiguous radius 218A of convex surface 218 defining a cooperative surface along a portion of a partially spherical-arc surface (e.g., along the transition between the vertical and horizontal positions).

Obviously, those skilled in the art will recognize, that since sample tube holder 203 is cylindraceous, it can rotate about either axis in either position and throughout arc 217 (FIG. 5). It is therefore suggested; that the present design provides a mechanism or a system for providing cooperatively contoured surfaces allowing smooth pivoting motion throughout a centrifugal cycle without unintended specimen remixing while also limiting tube rattling.

A waist region 207, of cylindraceous sample tubes 203, includes an arcuate transition surface 208 forming a second contiguously cooperative surface portion matching the first cooperative surface portion along contiguous region 218A. As a consequence, the cooperative surfaces (first and second) nest smoothly together and allow a smooth cooperative sliding motion during use.

As a consequence of the present design, both sample holding unit 202 and sample tube holder 203 are referred to as including contiguous cooperative surfaces that enable a smooth transition (without jarring) pivoting between positions 215, 216.

As earlier noted, a common problem in centrifugation is the positioning of sample tubes in non-symmetrical positions. This problem was particularly acute where there were no markings, or where the markings were only alphanumeric. The present invention cures this problem by providing sample holding unit 202 with clear visual indicators or indicia (not shown) along transition surfaces proximate each respective biaxial opening 410. These indicia are similar on opposing sides of a central axis of holding unit 202, and are commonly a visual pattern (check, dotted, striped, etc.), but may also be a color (blue, red, etc.), or combination of both allowing a rapid user-determination of opposite openings 214.

As an additional feature of the present invention, each orifice or opening 210 of sample holding unit 202 includes a smooth back radius portion or concave surface 221 matching an external diameter of sample tube holder 203. Each orifice or opening 210 also includes a smooth front radius portion or concave orifice 222 matching the external diameter of sample tube holder 203. This construction allows the surfaces of 210 openings to securely contact sample tube holder 203 about an actuate region and a portion of it's cylindrical body wall, thereby preventing sample holder units twisting or rattling and non-radial movement relative to a sample holding unit center. See FIGS. 5A and 5B.

In view of the above description, those skilled in the art should recognize that openings 210 have surfaces with the additional cooperative elements discussed, thereby forming a system for ensuring specimen radial alignment, preventing sample specimen rattling during use, and during any necessary unit 100 transport or sample holder unit 202 transport. As a consequence, the present invention substantially minimizes unintended specimen rattling throughout a use-cycle, and the resultant undesirable sample remixing. As a result, the present invention enables centrifugation of much smaller specimen volumes than previously achievable by drastically reducing remixing and preserving a centrifuged specimen.

As shown, sample holding unit 202 may alternatively be referred to as a sample holding tray, and may be readily adapted for the separation of particles or items either by weight or within a gel or both.

Referring now to FIGS. 6A and 6B, rotatable carrier assembly 200 includes motor cover or motor housing cover 201 in combination with a removable sample holding unit 223 (or sample tray 223) having a plurality of sample slots 228 enabling a sample tube holder 203 (or sample holder). Sample holding unit 223, similar to sample holder unit 202, is removably secured to lower portion 209 of motor cover or motor housing cover 201.

Each sample slot 228 includes a first horizontal radiused surface 229 corresponding to the radiused cylindrical walls of sample tube holder 203, and preventing unintended lateral or non-radial movement of sample tube holder 203 to minimize sample rattling and jarring. Each slot 228 also includes a cooperative surface 230 that smoothly contacts cooperative surface 208 on each respective sample tube holder 203 and prevents the sample tube holders from sliding radially away from motor cover 201 during use, while allowing a smooth non-jarring pivot in an optional construction, discussed below.

In one optional construction for sample holder unit 223, a second radiused surface 231 is set at a pre-selected angle, between 75 and 10 degrees below first horizontal radiused surface 229. Second radiused surface 231 is formed similarly to first radiused surface 229 and correspondingly minimizes non-radial movement of sample tube holder 203.

In this assembly, contrary to that described above, a specimen within sample tube holder 203 is preferably separated by gel that will resist remixing (induced by the gravitational field) upon the termination of centrifugation. Second radiused surface 231 allows a user to securely position a gel-based specimen within a sample tube holder allowing the angled slope to prevent the slow movement of the gel while the remaining sample slots 228 are filled. During use, the sample tube holders resting within second radiused surface 231 pivot about the cooperative surfaces along arc 233 to assume a horizontal position allowing the gel separation to advance. Where sample holding unit 223 is not provided with second radiused surfaces 231, sample tube holders 203 remain in the horizontal position throughout the cycle.

Obviously, while a capped fluid specimen may be centrifuged in this assembly, upon termination of centrifugation the separated fluid specimen would remix degrading specimen quality substantially. The principal benefit of the present sample holding unit design is the low physical profile and easy access.

Also show are stack support surfaces 232 on gel separation sample holding unit 223 proximate motor cover or motor housing 201. As will be obvious to those skilled in the art, where two sample holding units 223 are stacked (FIG. 6B) forming a combined multi-stack sample holding unit 224, support surfaces 232 support each respective layer.

As will be obvious to those skilled in the art, adaptive multi-stack sample holding unit constructions may be provided without departing from the scope and spirit of the present invention.

Referring now to FIG. 6C, rotatable carrier assembly 200 includes motor cover or motor housing cover 201 and a film separation sample holding unit 225 removably secured to lower portion 209 of motor cover 201. This special arrangement enables ready separation via a gel or film forming process wherein the desired part will settle on vertical walls 234 of respective sample chambers 235 during centrifugation. Optionally, a removable insert or other sealed sample cartridge or holder (not shown) may be securely positioned within a sample chamber 235 for centrifugation. Each sample chamber 235 is supported by a tray support 236 projecting outwardly and laterally away from motor cover or motor housing cover 201. Vertical walls 234 are generally parallel to the axis of rotation for motor cover 201.

A plurality of strengthening and alignment slots 237 project radially from motor cover 201. Slots 237 serve to stiffen the generally planar construction of tray support 236 and minimize harmonic wobbling created by air resistance, slight variations in sample weight, or other factors.

In some embodiments, a single sample holding unit 235 may include four, six, eight or more sample chambers 235 balanced about an outer periphery of tray support 236.

In still a further alternative embodiment, alignment slots 237 are provided with matching recess (not shown) on a bottom surface of each tray support 236. In this embodiment, multiple tray supports 236 may be positioned on each other, allowing an engagement between the recesses (not shown), and respective alignment slots 237. This recess/slot engagement mechanism engagement prevents multiple tray supports 236 from rotating relative to each other and eases ready stacking to improve sample volume. As a present example, two sample holding units (as shown in FIG. 6C), may be positioned at right angles to each other and enjoy the recess/slot engagement mechanism to prevent respective rotation while doubling the specimen volume during each centrifugation.

In a further alternative embodiment, sample chambers 235 may be provided in an interchangeable manner with tray support 236, allowing ready separation from support 236 (and later reengagement) for further processing and/or pre-staging of multiple sample chambers 235 prior to additional centrifugation. In this embodiment, a user may acquire a single tray support with a plurality of differently shaped and sized sample chambers 235, allowing ready interchangeability and adaptation to a desire sample size or text matrix.

The construction may also include additional matching weights, thereby allowing a first sample chamber 235 to be inserted on tray support 236 at a first position, and a differently weighted sample chamber 235 to be inserted on tray support at a second position, the difference in weight being employed to satisfy the need for a matched weight during centrifugation.

Each sample chamber 235 includes back wall 234 formed as optionally a planar flat wall (truly flat), or as a slightly arcuate shape (as shown) aligned with a circumference defined by the swing of tray support 236 during operation. Both operations provide advantages to a film separation process.

Where the back wall is planar the centrifugal forces vary slightly across its surface (since only the centerline of the back wall circumscribes the true diameter). Thus, a planar back wall may experience slight non-perpendicular force vectors during use, allowing non-exact radial particle separation. Where this concern is minor, for example in gross sample preparation, this type of sample chamber may be used. The benefit is that, being formed in a planar condition, the resultant product will not have to be further flattened upon withdrawal from the sample chamber.

Where the back wall is arcuate (as shown) the gel separation process will experience substantially uniform centrifugation forces across the entire wall face minimizing specimen variation. The detriment to an arcuate back wall is that the resultant product will need to be further flattened upon withdrawal from the sample chamber.

In either circumstance, the present alternative embodiments discussed above, allow the ready separation of particles in a gel specimen and easy adaptation to a wide variety alternative combinations, assemblies, stacks, and adaptations responsive to expectant customer needs.

In yet another alternative embodiment, a sample-holding unit 225 may be provided with a modified continuous sample chamber (not shown) completing the entire available circumference within the centrifuge (for example 25 centimeters in diameter). Such a sample chamber would be joined at a top and a bottom section by a support to prevent non-circumferential operation while allowing easy separation of a continuous film the length of the entire centrifuge diameter. This construction may also be modified to provide a U-shaped radial cross-section for the sample chamber allowing, again, a continuous film formation.

Referring now to FIG. 6D, rotatable carrier assembly 200 includes motor cover or motor housing 201 and a sample holding unit 226 combining both the sample chamber 235 design discussed above in FIG. 6C, and the gel separation designs noted in FIGS. 6A and 6B.

Those skilled in the art will also recognize that the present combination may be additionally modified to include or integrate the sample holder unit design 202 noted in FIG. 5, as long as the principal guiding balanced mass distribution (symmetry) is maintained to minimize undesirable vibration during operation.

As shown in FIG. 6D, both assemblies involve gel-based type separation system sample holders, and as a consequence, sample holding unit 236 may be preferred by certain users conducting solely gel-based centrifugation. As should also be recognized, two or more sample holding units 226 may be stacked, resting on respective stack support surfaces 232 and a balanced position minimizing rotational vibration. As an example, two sample holding units 226 may be position generally perpendicularly on motor cover or motor housing cover 201, thereby distributing their mass in a balanced manner about the central axis of motor cover 201 and minimizing rotational vibration and eccentric tendencies.

Referring now to FIG. 6E, in this embodiment rotatable carrier assembly 200 includes motor cover or motor housing 201 and a sample holding unit 227, as shown. Sample holding unit 227 includes tray support member 236, formed as previously discussed and stiffened by strengthening alignment slots 227 to diminish flexing at high rotation while enabling multi-stacking.

In considering this embodiment, the present disclosure again incorporates by reference the disclosures in U.S. 2004/0071786 or U.S. Pat. No. 6,368,298 regarding sample analysis and use in the formation of biological materials to reduce healing time and minimize healing discomfort.

As shown, two pivot assemblies 238 extend at opposite sides of tray support 236. As will be understood from the above discussions, additional pivot assemblies 238 (in balanced sets) may be additionally positioned about the outer perimeter region of tray support 236. As will be additionally understood from the above discussion, alternative embodiments may provide multiple sample holding units 227, stacked in layers, allowing complementary alignment slots 227 to intermesh and prevent relative rotation during use. When multiple sample holding units 227 are stacked, they are positioned in a balanced manner minimizing vibration during rotation.

Each pivot assembly 238 includes a receiving support (not shown) for removably receiving and supporting a multi-sample holder 239. The receiving support is pivotally suspended within frame set 241, as will be described. Multi-sample holders 239 are commonly used during laboratory analysis where many small specimens need to be transferred via pipette for later analyzed or where analysis is conducted in concert with an automated testing device capable of being “mapped” to sample and test individual sample openings 240 arrayed across the scope of multi-sample holder 239.

For example, multi-sample holders 239 are commonly used during pipette-sample transfers, mass spectrometry, immunoassays, investigation of enzymes or micro-organisms, and for testing blood and other biological fluid components in small volumes, or for forming small volumes of biological material (including fibrin components or others) for later testing. Multi-sample holders 239, commonly used in pipette-based analysis, are provided in a wide variety of designs with differing numbers and sizes for sample tubes 240.

In the past, it had been extremely difficult, if not impossible, to apply centrifugation to these types of multi-sample holders 239 as an entire block. One substantial detriment to any effort to centrifuge a multi-sample holder 239 is the requirement that the separating force be provided generally along the length of each individual sample tube 240 throughout the complete centrifugation process (start to stop) to both achieve the desired separation result and prevent disastrous remixing. Since each sample tube 240 is very small, often including only a few milliliters or grams of sample material, any unintended remixing usually voids the analysis, requiring costly retesting. According to the present invention, pivoting assemblies 238 provide an operable mechanism for both centrifugation, and in situ pivoting to minimize or eliminate remixing throughout the centrifugation process.

Those of skill in the art will recognize that the present design may be modified without departing from the present spirit and scope. In one adaptive embodiment, multi-sample holder 239 may be fixed in respective pivot assemblies 298, to act as receiving support for a disposable and insertable multi sample holder known in the art (not shown), wherein each individual tube (joined along a common interface, slips within corresponding individual sample tubes 240 for support and retention during centrifugation.

As noted above, each pivot assembly 238 is rotatably supported within frame set 241 along a pivot axis T by pivot pins 242 rotatably positioned within respective pivot holes 243. Pivot pins 242 allow pivot assembly 238 to rotate through arc S during use, between a first position R and a second position Q (shown in dashed outline) throughout the centrifugation process. This pivot mechanism enables the separating force to be aligned generally along the length of each individual sample tube 240 while also enabling a smooth transfer along arc S to substantially eliminate remixing biological specimens.

While not shown, a spring assembly or member (not shown) functionally joins pivot assembly 238 to frame assembly 241. The spring assembly (not shown) provides a variable spring rate throughout a centrifugation cycle and enables a mechanism for pivoting pivot assembly 238 to continuously reposition multi-sample holder 239 in respect to the centrifugation force, even under heavy electronic breaking. The spring assembly allows the present invention to rapidly adapt to variable centrifugation forces, and rapid changes in force, while minimizing remixing and preserving sample integrity.

In the embodiment shown, frame assembly 241 optionally includes pivot-guiding slots 244 for slidably guiding slip pins 245 joined to each side of pivot multi-sample holder 239. In combination, pivot guiding slots 244 and slip pins 245 provide a rotating guidance throughout pivot arc S between position R and position Q, and minimizing misalignment as a further quality improvement provided by the present invention.

While pivot assembly 238 is discussed in combination with multi-sample holder 239, the present invention also discloses alternative adaptive embodiments wherein a replacement sample holder (not shown), allows the use of a flat film-forming specimen support (for example during the formation of an antilogous fibrin maternal as discussed above in a process similar to those noted in U.S. 2004/0071786 or U.S. Pat. No. 6,368,298. In this manner, the embodiments noted may be used for direct film formation in a flat shape eliminating the need for slitting a film formed in a cylindraceous centrifugation manner.

The present invention again incorporates by reference the disclosures in U.S. 2004/0071786 and U.S. Pat. No. 6,368,298, which discuss a method for preparing a solid-fibrin web, wherein the method may include steps of drawing blood from a patient, separating plasma from the blood according to one embodiment of the present invention contacting the plasma with a coagulation activator and concurrently coagulating and centrifuging (see above and employing a selected sample holding unit noted in FIGS. 6A through 6E), the plasma to form a solid-fibrin web suitable for supporting and ideally regenerating body tissue in a living organism. The solid-fibrin web may be formed to specifically contour a portion of the human body in need of regeneration of the body tissue.

As earlier noted, advances in the Human Genome Project have demanded innovative solutions to sample preparation in the ever changing landscape of molecular labeling and manipulation, gene mapping, gene expression, amplification, DNA sequencing and proteomics. Sample preparation has often been a bottleneck to the analysis of complex biological materials, especially in high throughput automated applications employing multiple sample sets such as genotyping and DNA sequencing.

While the general analysis of specimens, fluid and gel, and the formation of fibrin glue have been discussed; the present invention may also include a process for platelet separation within the scope of its biological sample handling capacity. Substantial wound healing features have been achieved employing platelet Rich Plasma, presumably by the release of platelet-derived growth factor (PDGE) and transforming growth factor beta (TGF-B), as well as a fibrin-rich base that provides early tissue revascularization and a framework for epithelial migration. In sum, the present invention provides a substantial improvement in sample preparation capacity to research and generate therapeutic solutions to medical needs.

The present invention also provides improved creation of near net shape biological tissues (for example, replacement cartilage and specially formed tissue replacements), by eliminate the prior art unrolling step, and allow large film forming shapes at electronically controllable centrifugation forces.

In one aspect of near net shape formation, the present invention may include specially formed trays having a mold shaped for a particular body part, for example the skin on an eyelid. Employing the present sample preparation process, autologous fibrin glue may be formed as a two dimensional near net shape film for easy replacement by a surgeon, without the damaging effects and risks of cutting a preformed rectilinear sheet to a desired form. In a second example, a three dimensional form (for example an ear or nose) by be positioned (with a duplicate for balance) on a flat surface rotatably supported in respective pivot assembly 238. Employing centrifugal force, a biological film (for example a fibrin glue) may be formed on the three-dimensional form, allowing simplified transplant to a patient.

In sum, the use of non-human and hetrologous cells and tissue transplants increase patient risk of allergic reaction and of blood born diseases. Therapies aimed at the reduction of healing time and addressing these issues require support from improved sample preparation and film formation techniques. The present invention provides solutions to these needs.

In each combination and alternative embodiment noted above, each sample holding unit or alternative design or combination may be sold separately (in kit form) from motor cover 201, allowing ready adaptation to a diverse customer base along differing marketing lines.

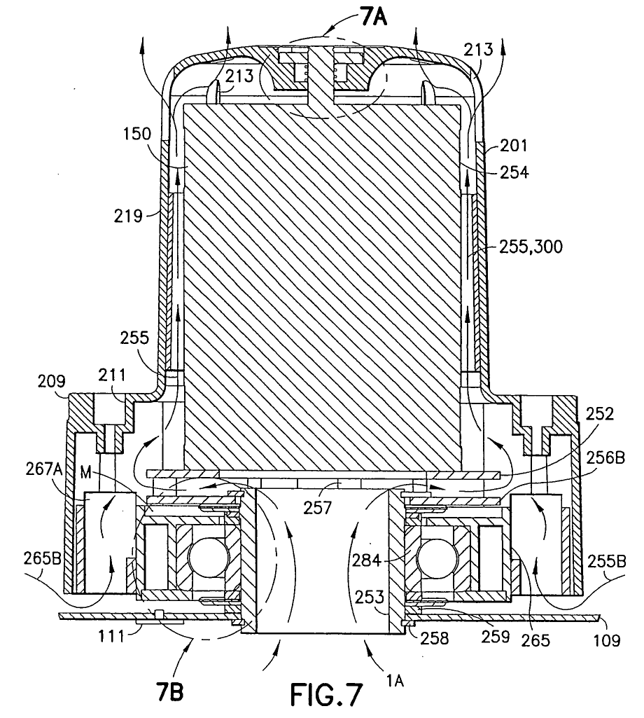

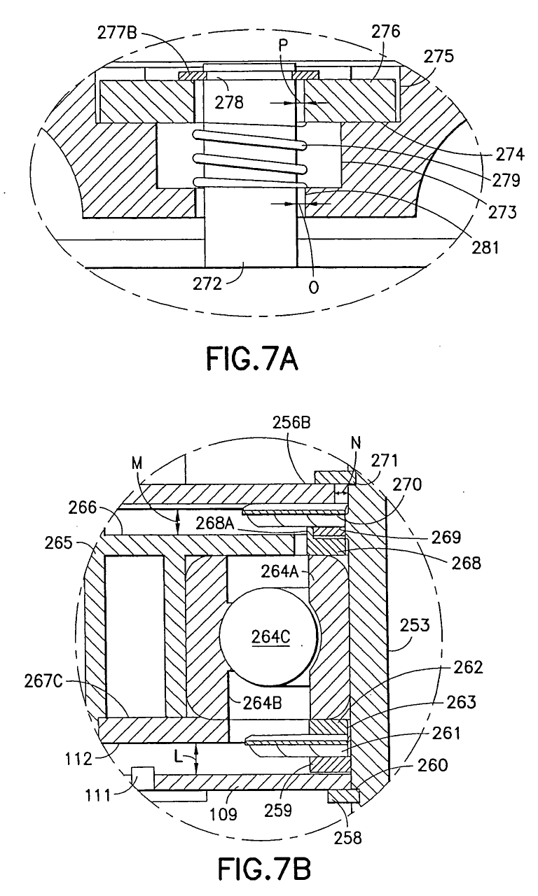

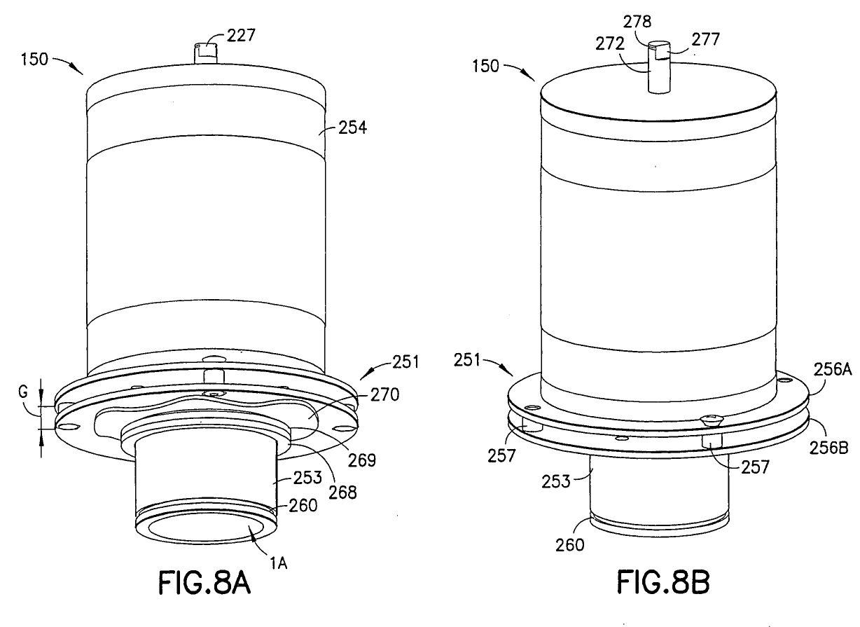

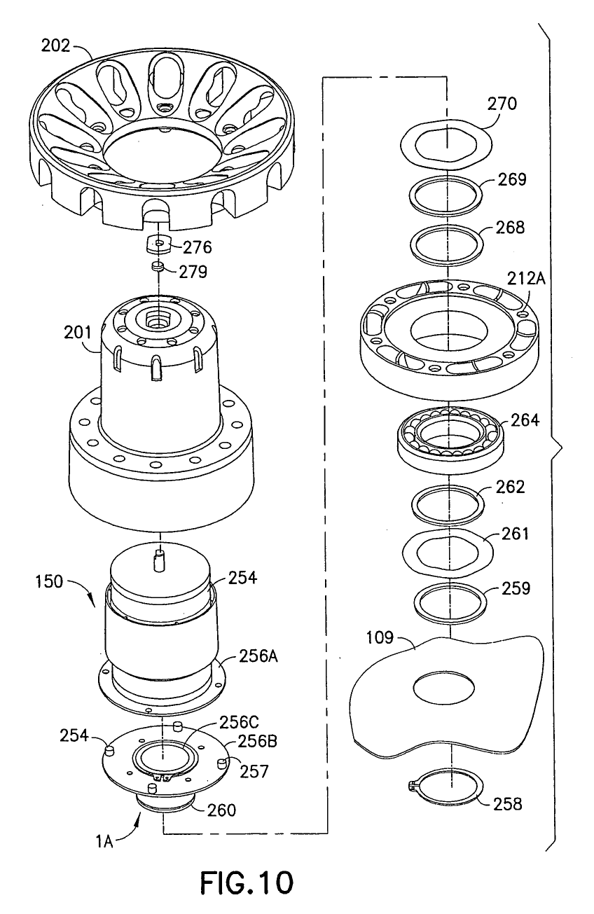

Referring now to FIGS. 7 through 11, motor assembly 150 is covered by motor cover or motor housing cover 201 including a plurality of vent openings 213 along an upper portion 219 thereof.

Motor assembly 150 is positioned on a pedestal assembly 251, flexibly linking a base plate 109 to a motor base plate assembly 252 along a vertically-extending mounting element 253 bounding ventilation aperture 1A. A motor 254 is cylindraceous and includes an outer surface member including one or more ventilation openings allowing warm air to escape motor 254. Motor 254 has a first outer diameter that is less than an inner diameter of motor cover 201 allowing air flows 255 to pass from pedestal assembly 251 upwardly between motor 254 and the inner diameter of motor cover 201 and pull warm air outward through vent openings 213 and into air management system 300 for later exit through air openings 304. In this way, air management system 300 enables centrifuge assembly 100 to cool motor 254 principally, and also cool specimen holders and the specimens themselves as discussed earlier.

Pedestal assembly 251 includes a top support plate 256A and a bottom support plate 256B. Bottom support plate 256B includes a ventilation aperture 256C and is firmly fixed to, and spaced from, top support plate 256A by a plurality of studs 257 forming an opening G between each plate for cooling airflow.

Vertically extending mounting element 253 projects from base plate 109 and is firmly fixed by slip ring 258 retained within a groove 260, and prevented from upward motion thereby. A first fixing washer 259 surrounds vertical element 253 on base plate 109 and prevents unintended separation between base plate 109 and vertical element 253, as shown. As a consequence, vertically projecting mounting element 253 is firmly fixed to base plate 109 and housing assembly 101. Vertically projecting mounting element 253 supports both rotatable carrier assembly 200 and motor assembly 150, and due to the high speeds involved must be firmly secured to the inflexible base plate 109. Other methods for joining mounting element 253 may be employed without departing from the spirit and scope of the present invention.

A first wave washer 261 and a sliding washer 262 are positioned about vertical mounting element 253 at a bottom portion, as shown best in FIG. 7B. An inner diameter of wave washer 261 and sliding washer 262 is slightly larger than the outer diameter of mounting element 253 providing a slight movement gap 263 for lateral adjustment and compensation as will be described.

A strong bearing assembly 264 has an inner race 264A and an outer race 264B that support a plurality of ball bearings 264C. Preferably, bearing assembly 264 is selected to enable rotational speeds well in excess of any predicted rpm design range.

An impeller and support assembly 265 includes an upper support member 266, extending from an inner diameter region and covering a portion of bearing assembly 264, outwardly to an outer impeller array 267. Impeller array 267 includes a plurality of impeller blades 267A positioned within a plurality of corresponding openings 267B, as shown.

Impeller blades 267A may be shaped in any convenient manner to promote air flow, but as shown are slanted off the vertical and are curved about an arc to “scoop” air upwardly and impart a vertical motion to the air to draw air from ventilation aperture 1A, air chamber 301, and elsewhere to aid motor cooling and support air management system 300.

A separable bottom member 267C defines an inner bounding region (shown but not numbered) proximate mounting element for receiving and securing strong bearing assembly 264 within impeller assembly 265, as shown. As shown best in FIG. 7B, bottom member 267 contacts a bottom of outer race 264B and secures the same to upper support member 266, thereby integrating bearing assembly 264 with impeller and support assembly 265.

Motor cover or motor housing cover 201 is secured to an outer perimeter of impeller assembly 265 via openings 212 (noted above) and corresponding threaded receptacles 212A by threaded bolts (not shown). In this manner, motor cover 212 is removably secured to impeller assembly 265.

While the present assembly suggests one preferred embodiment, those skilled in the art may reposition elements and achieve the same function without departing from the spirit and scope of the present invention.

Bearing assembly 264 and impeller assembly 265 are assembled as shown, and positioned firmly about mounting element 253 where inner race wall 264A aligns with and contacts the outer perimeter of mounting element 253. As a consequence of this assembly, the entire weight of impeller and support assembly 265 is born by strong bearing assembly 264 that, in turn, is firmly supported by sliding washer 262 and wave washer 261. The firm contact between inner race wall 264A and mounting element 253 provides firm alignment between impeller assembly and support base 109, and prevents inner race wall 264A from rotating relative to mounting element 253.

A washer 268 is positioned on a top portion of inner race wall 264A and includes a slightly larger inner diameter than the outer diameter of mounting element 253 allowing slight relative movement thereto. Washer 268 includes an outer lip portion 268A projecting upwardly to contain a washer 269 tightly sealed to the outer diameter of mounting element 253, as shown to additionally secure impeller assembly 265 and bearing assembly 264 firmly to mounting element 253.

In view of the above assembly, it should be obvious to those skilled in the art that any sample weight transmitted to impeller and support assembly 265 via motor cover or motor cover housing 201 is transferred to mounting element 253 through strong bearing assembly 264.

It should also be apparent to those skilled in the art, that the present assembly enables motor cover housing 201, impeller support assembly 265, and bearing to flex only slightly vertically by compressing wave washer 259. It is also noted, that the present assembly spaces impeller assembly 265 a vertical distance L from base plate 109 to accommodate this very slight flexing. As designed, wave washer 259 has a substantially strong bending moment and is compressed by press-fit installation of strong bearing assembly 264.

Since wave washer 259 provides strong elastic urging between fixed base plate 109, and pressure fit inner race wall 264, no real lateral movement is allowed and only slight vertical movement is allowable or expected, but the assembly serves to further dampen vibration and flex within distance L. As will be later described, pedestal assembly 251 additionally serves to pre-stress bearing assembly 264 to increase bearing life and improve smooth running.

A wave washer 270 is positioned on fixing washer 269 to support a bottom portion of bottom support plate 256B. Wave washer 270 spaces bottom support plate 256B of pedestal assembly 251 a vertical distance M from the top of upper support member 266, as shown. It should be noted, that upper support element 266 of impeller assembly 265 is recessed a slight distance (distance M) from the top surface of impeller array 267. As a consequence, it should be noted, that upon full compression of wave washer 270, bottom support plate 256B will enter the recess to aid the self-centering and compensating mechanisms of the present invention, as will be discussed.

It is also noted, that vent aperture 256C of bottom support plate 256B is larger than an outer diameter of mounting element 253 by a lateral distance N on each side.

A second slip ring 271 is received within a retaining groove about a top diameter of mounting element 253, and secures the bottom support plate 256B on top of wave washer 270, flexibly joining pedestal assembly 251 (and motor 254) to mounting element. As discussed above, second wave washer 270 has a very high spring rate and substantially resists compression, but remains sufficiently flexible to enable the lateral sliding and self-centering and compensating mechanisms of the present invention.

Motor 254 includes a drive shaft 272 projecting upwardly through an opening 281 into a receiving cavity 273 within the top portion of motor cover 201. A slight gap O is provided between the outer diameter of drive shaft 272 and the inner diameter of opening 281. Receiving cavity 273 includes a step 274 forming a key retaining area 275 for receiving a key 276.

A flat surface 277B on drive shaft 272 engages a corresponding flat surface on an inner opening in key 276 to prevent relative rotation there between. While not required, in one alternative embodiment, a slight lateral distance P exists between an external diameter of drive shaft 272 and a part of the inner opening in key 276. In this alternative embodiment, flat surface 277B continues to engage key 276 to prevent relative rotation, but slight lateral movement is allowed via distance P to compensate for vibration, eccentric motion, and specimen weight differences.

A slip ring 277 within a groove 278 covers receiving key 276 and prevents unintended separation between receiving key 276 and drive shaft 272. A firm spring 279 is compressed within receiving cavity 273 between a floor of receiving cavity 273, and receiving key 276.

Firm spring 279, and the arrangement provided, enables substantial benefits to the present invention. Initially, firm spring 279 keeps key 276 firmly engaged with portions of drive shaft 272 preventing separation and relative rotation. Additionally, spring 279 provides an urging force on drive shaft 272 keeping internal motor bearings (not shown) in motor 254 from spinning freely and damaging the motor. For optimal function, bearings should be kept under slight compression. Still further, spring 279 may place slight tension on strong bearing assembly 264 and similarly prevent free rotation for optimal bearing performance. Finally, spring 279 enables a slight shifting between drive shaft 272 to facilitate the alignment and eccentric compensation mechanisms noted herein.

During operation, it should be understood, that weight from specimens, and rotatable carrier assembly 200 (including all weight from sample holding units), is born by a strong rotating bearing assembly 264 via support and impeller assembly 265, and not by rotational shaft 272. Rotational shaft or motor shaft 272 serves only to impart rotational force to rotatable carrier assembly 200 for centrifugation of specimens. As a result, the present invention provides a mechanism or system to eliminate sample-bearing weight on a centrifuge motor drive shaft while substantially reducing a center of gravity.

It will be understood, that larger motors have larger internal bearing assemblies, but in general no small-sized centrifuge motor includes internal bearings of the size and strength of strong bearing assembly 264. Thus, as a consequence, of the present designs, where the rotating sample carriers are not fixed or directly attached to the drive shaft, there is a substantial increase in both motor life, and sample weight capacity beyond the designs previously provided. This may be referred to broadly as a mechanism for correcting misalignment/realignment of the motor assembly and motor cover housing assembly.

As noted above in reference to FIG. 3, FIG. 11 provides an alternative construction to an electromagnetic cover locking mechanism 20B including a horizontally moving locking bracket 25 joined to a solenoid 29 within a cover edge member 28 for engaging cover assembly 102 and locking it firmly to base assembly 103. Springs 27 enable a rapid release/engagement of locking bracket 25 depending upon solenoid movement.

One benefit of the present design is that it is completely retained within cover edge member 28 and electrically joined to electronics assembly 250. This operable connection to electronics assembly 250 enables a substantial safety improvement by preventing unintended lid opening during rotation or excessive vibration. Locking mechanism 20B may also be programmed to lock at a beginning of a programmed operation and open at the end, providing convenient safety. While additional elements are noteable within locking mechanism 20B, including security mechanism 20C, it is important to understand that in one preferred embodiment, locking mechanism 20B is integrated with electronics assembly 250.

As discussed earlier, conventional centrifugal devices are also incapable of self-centering in situ (during operation) adjustment. According to one aspect of the present invention, when motor assembly 150 is not centered relative to rotatable carrier assembly, pedestal assembly 251, wave washer 270, and the other mechanisms for self-centering noted early allow motor assembly 150 so shift slightly along the surface of wave washer 270 using distance N to compensate and achieve a proper center condition.

As a further measure of the adaptive self-centering capacity and suspension benefits of the present invention, motor assembly 150 may also shift using distance M to compensate and achieve a centered orientation. Due to the substantial forces exerted by even slight differences in sample weight, and the corresponding damage created by the resultant vibration, the present invention has a substantial beneficial impact on centrifuge life.

To understand this condition, we may consider first a conventional centrifuge with a rotatable sample tray fixed to a drive shaft of a vertically positioned motor. In this conventional centrifuge, the outermost edge of the sample tray operates as the furthest lever-point, and the rigid junction between the drive shaft and the sample tray acts as the lever's fulcrum. As a consequence, a slight change in mass, or variation in mass about the outermost edge of a conventional sample tray has a magnified impact on the drive shaft and imparts a substantial bending moment upon the rigid junction. These substantial forces must be absorbed by the motor's internal shaft bearings and frequently cause premature failure and excessive heating.

In contrast to conventional designs, one may consider the entire rotatable carrier assembly 200 as a moment arm, with the outermost position of a respective sample holding unit acting as the furthest lever-point, and the interconnection at drive shaft 272 as a possible fulcrum. Since the present invention provides a complete independent suspension for carrier assembly 200, meaning that all weight is born directly by strong bearing assembly 264, no weight or bending moment is transferred to drive shaft 272 and no true fulcrum can exist. Drive shaft 227 only functions to impart rotational energy to rotatable carrier assembly 200, and does not carry any weight. As a consequence, motor 254 enjoys increased operation life and cooler running conditions.

The present invention also compensates for any unbalanced force or vibration that may act upon drive shaft 272 and motor 254 by first elastically separating drive shaft 272 from the top of motor cover 201 through the use of spring 279 and thereafter allowing a slight realignment via optional space O, and in rare cases space P, and second by elastically allowing pedestal assembly to shift using distances M and N to absorb any eccentricities and off-center alignments.

Thus, the motor is weight-supported by the wave spring allowing lateral movement by sliding along the wave spring while retaining vertical integrity to recenter and compensate for specimen variation and eccentric movement. Furthermore, spring 279 in a slight way applies a pressure on bearing race 264 further preventing free non-contacting rotation and reducing bearing wears.

It should also be noted, that in one embodiment rotatable carrier assembly 200 can itself shift slightly along direction L relative to mounting element 253 to absorb substantial eccentricity and vibration. Since manufacturers may select variable spring rates for respective wave washers, the present system may be readily adopted to systems typically handling light or heavy loads without departing from the basic scope and spirit of the present invention.

In addressing the needs noted above, the present invention provides variable embodiments, wherein the motor axis and shaft do not bear pivoting weight and receive no bending moment, the motor is positioned “within” a rotatable carrier assembly providing a reduced profile, an independent suspension is provided for the sample holder and cover units, a simple vibration absorption, realignment, and reentering system readily adapted to a wide verity of analytical situations with varying weights, and an air and temperature management system increases cooling, reduces air interference.

With the above discussion in mind, we can now discuss several of the optional and unique electronic and system control features of the present invention provided within electronics assembly system 250 not easily depicted a physical-system based manor (as above). While several of these items/systems/functions/circuits have been previously introduced, suggested or discussed, others are introduced here for the first time.

These features are newly provided in a bench-type centrifugation system.

In alternative embodiments of the present invention a theory of operation, particularly for electronics assembly 250, is provided below including many specific and alternative features, but not limited to a microprocessor controlled centrifuge system with:

1. Programmable run-time and speed-set/rpm-set circuits with motor control functions are provided. These circuits are electronically adjustable via the control surfaces or buttons noted above, and enable both a continuous run-length and speed (rpm) adjustment in situ i.e. (while running). This system enables simple and prompt correction to preserve the integrity of a sample run, or modify a run to correct an initially incorrect time or speed input. This in situ correction capability provides convenient timesavings while preserving sample validity during scientific tests (prevents re-running samples and running samples for variable lengths of time).
1. In one embodiment, these circuits also enable simple electronic calibration and optionally a cycle counter.
2. In another system embodiment, a secure password entry is required to operate the system.
3. In yet another alternative embodiment, the circuits may include a warning notice (LCD display) area with a cut-off to require and provide notice of scheduled maintenance while initiating a motor cut-off to prevent operation after a scheduled maintenance date cut-off.

2. A digital display, in one case a four digit LED or LCD display, or several disparate visual displays, provide a visual operator/user feedback of various selected capacities, including time-set, time remaining, speed set, speed variation, repair notices, an eccentric and a vibration sensor warning and other control circuit warnings.
1. In one embodiment, a vibration sensor operably monitors the unit during each cycle and optionally provides a visual warning, an audible warning, and a break function operation when vibration exceeds a predetermined undesirable level.

3. In yet another alternative embodiment, the present invention may include a PID (proportional, integrative, and derivative) controller programmable via an operator keypad allowing specific control and maintenance of sample rpm and accelerometer control. Such a PID controller may be integrated with a self-calibration circuit or may remain separate from such a circuit.

4. An optional self-calibration system enables constant, or set time, monitoring of the present invention. This system may monitor at least one of motor rpm, motor current/voltage/power output, while also optionally tracking the number of centrifugation runs or total time at speed, total on-time (running) activity, or a predetermined amount of acceptable/unacceptable vibration.
1. In one example, the self-calibration system monitors a centrifugation run and senses that a desired rpm is not being maintained via a sensor 111 and sensible pattern 112 compared to a desired standard. As a consequence, the self-calibration system may electronically regulate the motor power to achieve the desired rpm.
2. In a second example, the self-calibration system monitors successive centrifugation operations (runs), and logs an amount of correction/motor regulation required to achieve a desired rpm into a tracking unit. The system monitors an acceptable amount of motor correction against this log (or a specific in-put set-point), and where the amount of correction/motor regulation exceeds the acceptable amount the system may generate a warning (audible/visual), shutdown the device (power control), or provide another indication of the need to conduct machine maintenance.
3. In another example, the self-calibration system enables true repeatable scientific analysis through a series of specimens. During conventional centrifugation specimens are often centrifuged for slightly different length times, resulting in sample variability. The present electronic control system enables sample exposure to a consistent and repeatable sample treatment run-to-run. This consistency enables improved scientific analysis and improves scientific research.
4. In another example, the self-calibration system may track runs and require a standard mandatory service repairs, for example at 5000 runs or at 10,000 runs, or more urgently if the system determines an unacceptable variation is occurring.

5. In another embodiment, one or more electronic brake function circuits or mechanisms are operably linked with selected motor, time, speed control, and various circuit systems, optionally including lid-open circuits, excessive vibration circuits, or maintenance monitoring circuits. Where a desired function is programmed, the break function circuits may be operated to apply either a physical-friction type break, or a motor-function break, thereby operably stopping one or more of a sample rotation and a motor operation a smooth and non-jerky manner. An electronic break serves to minimize jerky operation and specimen perturbations during start/stop and concomitant specimen holder rotation while improving safety.
1. In one embodiment, the lid-open-solenoid is operably linked with at least one of the rotation/speed sensor and a motor control sensor, thereby prohibiting operation of the lid-open-solenoid until the rotor stops. Typically, the electronic brake employed is effective to stop rotation within about 20 seconds. This function serves to improve unit safety and minimize product liability risk.
2. In another alternative embodiment, a balance/off-balance sensor is provided and electronically and operably linked with the brake function, allowing the brake system to actuate and prevent operation when the system is inappropriately off-balance, thereby minimizing damage risk and sample disturbance.

6. In another embodiment an audible warning or cycle finished circuit may exist integrated with the other control circuits described above. This type of circuit may be triggered upon the end of an operation cycle, end of time limit, excessive vibration limit, or break operation, motor malfunction, circuit malfunction, or other unit control operation.

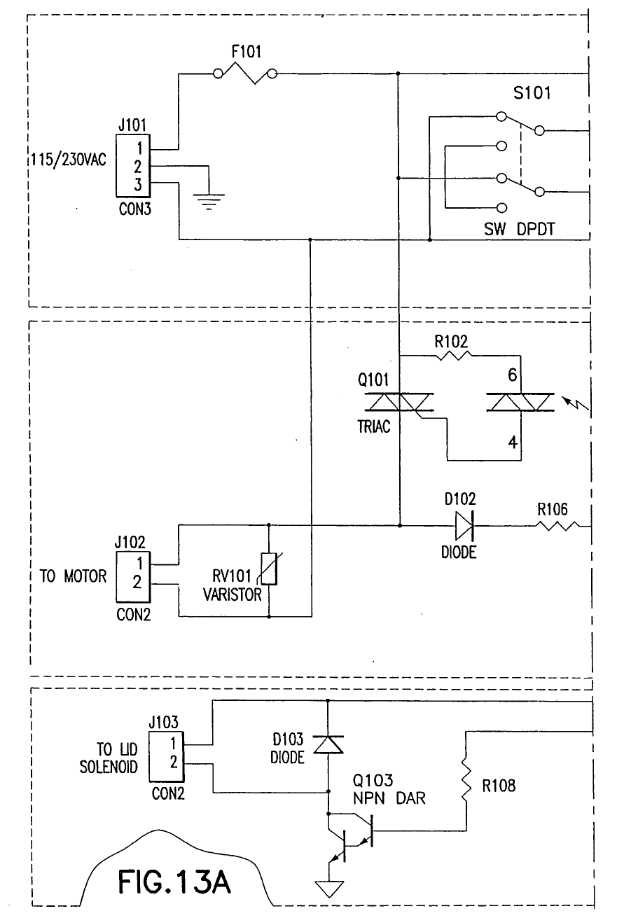

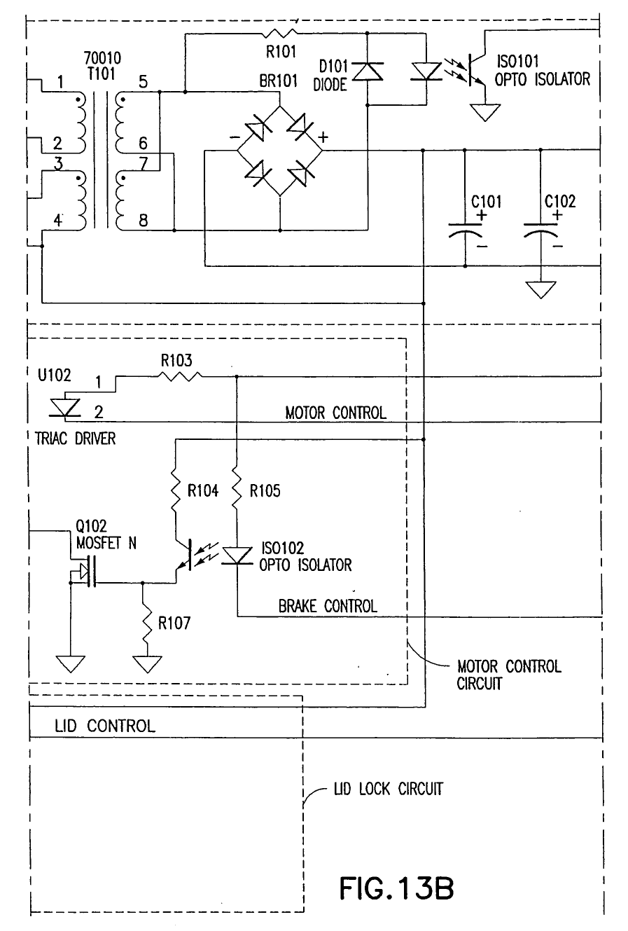

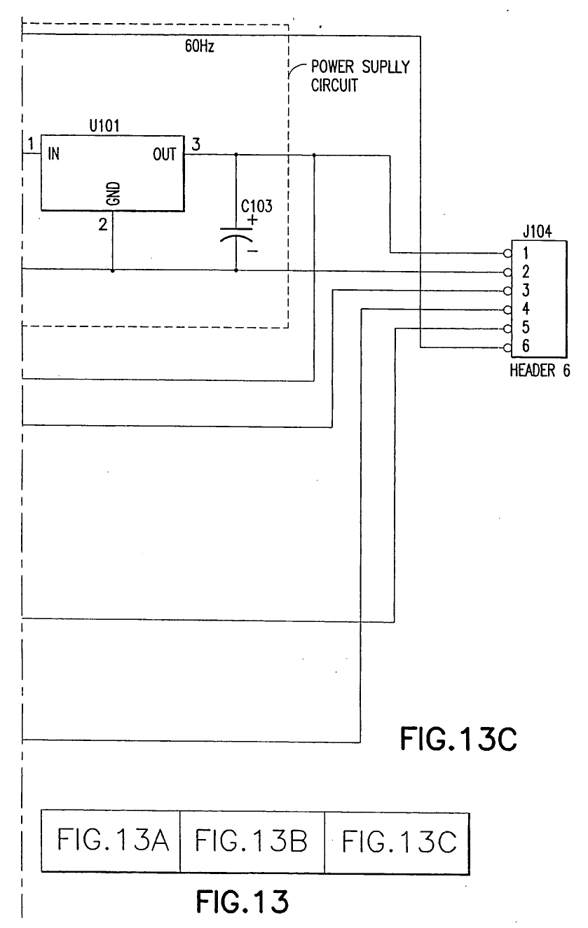

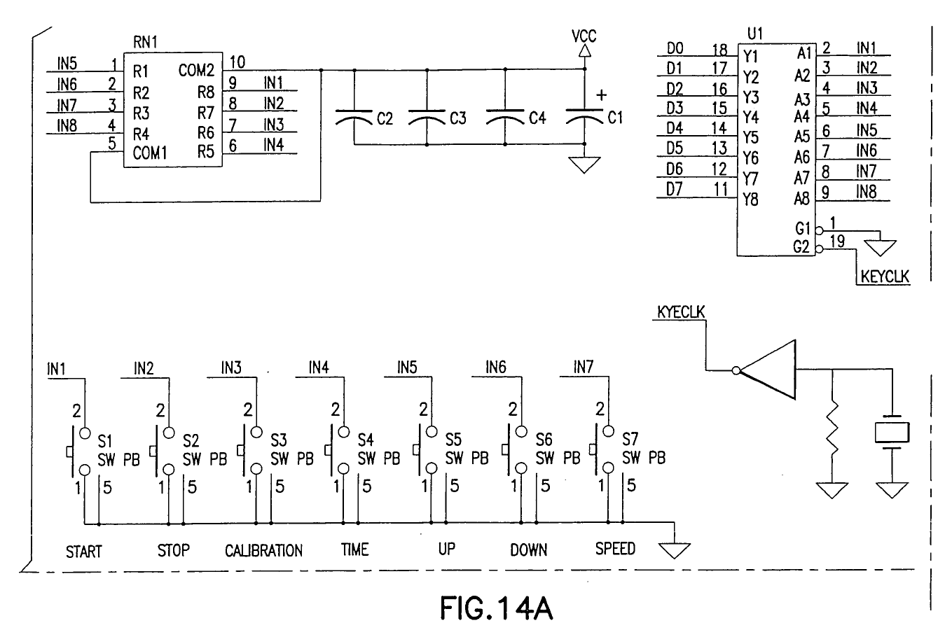

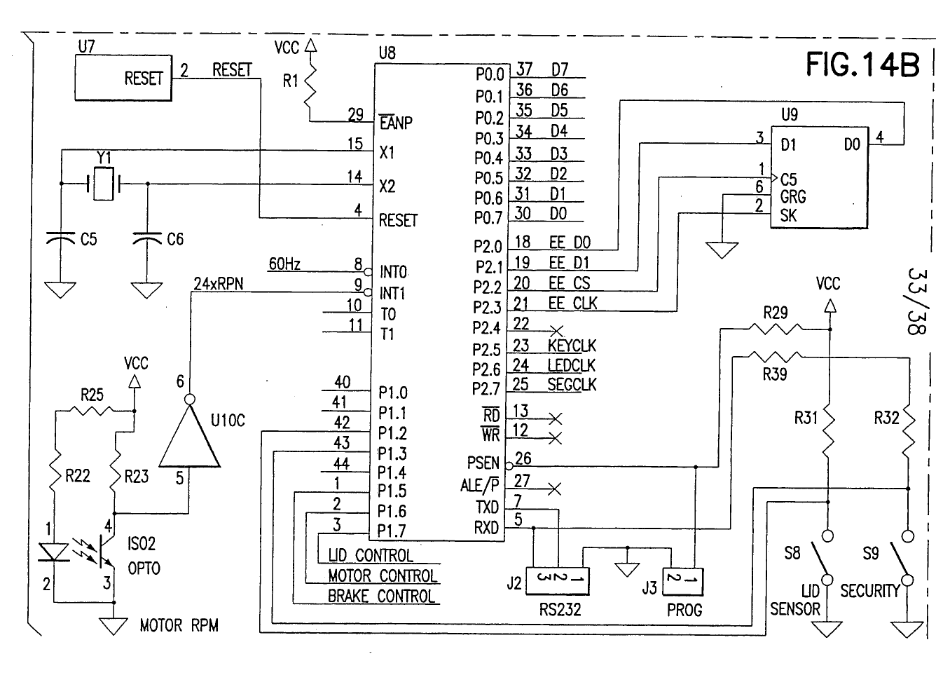

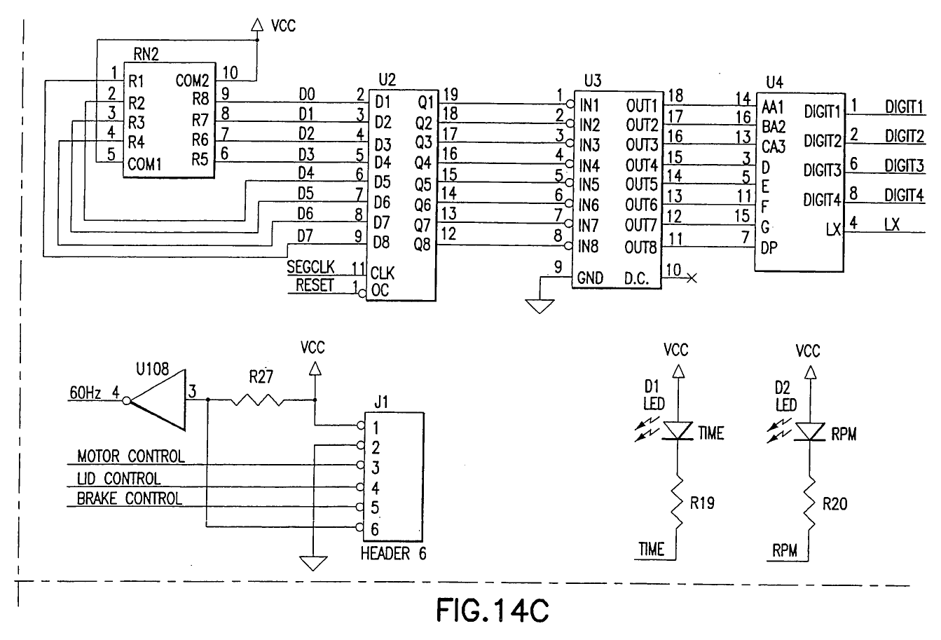

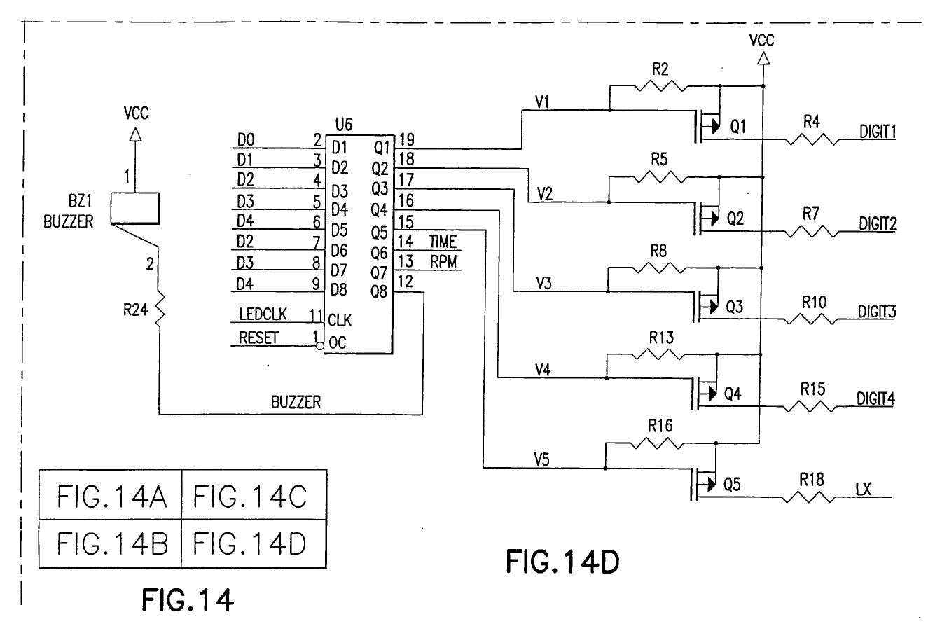

Referring now to FIGS. 13 and 14, in one embodiment an operable electronic assembly 250 includes multiple units, described respectively below including:

1. A microprocessor unit: A centrifuge controlled by a U8 microprocessor containing at least one executable program. The executable program is stored in the processor=s FLASH memory. The U7 reset circuit, the U9 NV memory, the Y1, C1 and C2 timing circuit belongs directly to the processor. During operation, the processor receives signals and sends commands through a data bus (D0-D7) and some direct port pins.

2. A display unit: The centrifuge display unit displays information about operation through a four-digit or other type display. The display is driven by the display driver circuit (U2, U3, U6, Q1, Q2, Q3, Q4, Q5) controlled by the processor. The visual display unit depends upon the operating mode, and can display at least the following:
Speed (RPM) and remaining time (mm:ss) in normal running mode
The desired speed or time in setup mode
The result of the calibration function result (IN RANGE, OUT OF RANGE)
Error messages (OUT OF BALANCE,?)

3. One or more push buttons: The centrifuge can be set up or operate by pressing the proper pushbutton or combination of pushbuttons. As shown in this embodiment, the pushbuttons are connected to the data bus through the U1.

D. Motor driver unit: The motor driver unit consists of two circuits, generally described as the motor driver and the motor brake circuits. As shown, the Q101 triac with the U102 triac driver supply the AC power to the motor. The triac controlled by the microprocessor according to the set up speed and the real speed. The real speed sensor is the ISO2 photo sensor. The Q102 MOSFET and ISO102 opto-isolator brakes the motor when the cycle finished or the STOP button was pressed.

E. A lid lock unit: During the operation the lid must be closed and locked for safety. In the present embodiment, the Lid-Lock mechanism is actuated by a solenoid and the solenoid is driven by the Q103 transistor.

F. A power supply unit: The power supply unit generates the necessary voltages for the controller circuit, the brake and the Lid-Lock circuit (T101, BR101, C101, C102, U101). Also the power supply generates the 60 Hz synchronizing signal for the speed control (ISO101, D101, R101).

G. Audible signals: If the cycle is finished or the centrifuge is in improper operation condition (excessive vibration, improper rpm, off balance, etc.), an audible signal sounds. This signal is controlled by the processor and generated by the BZ1 buzzer and may assume different tones, notes, or operation dependent upon the type of operation condition. Alternatively, a speaker and audio memory file system may be accessed to produce a predetermined recording.

H. Vibration sensor: In case of an unbalanced load the centrifuge can make uncontrolled movements, cause specimen perturbations, damage sample results, and cause remixing B often disastrous in particularly small sample sizes. To prevent this situation, the centrifuge equipped a motion sensor (Y2) connected to the processor. If the vibration is over the limit, the processor stops the centrifuge, the OUT OF BALANCE message appears on the display and an audible warning signal sounds.

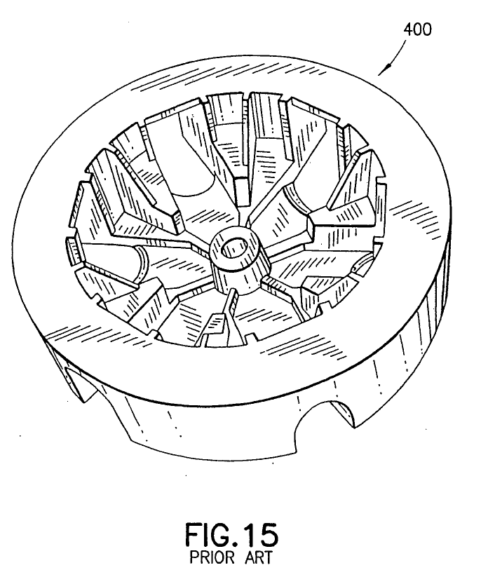

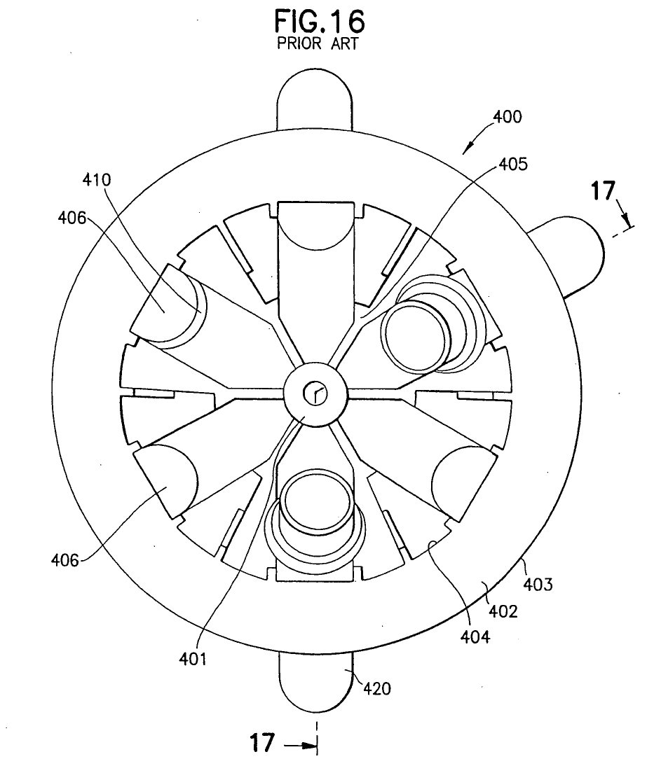

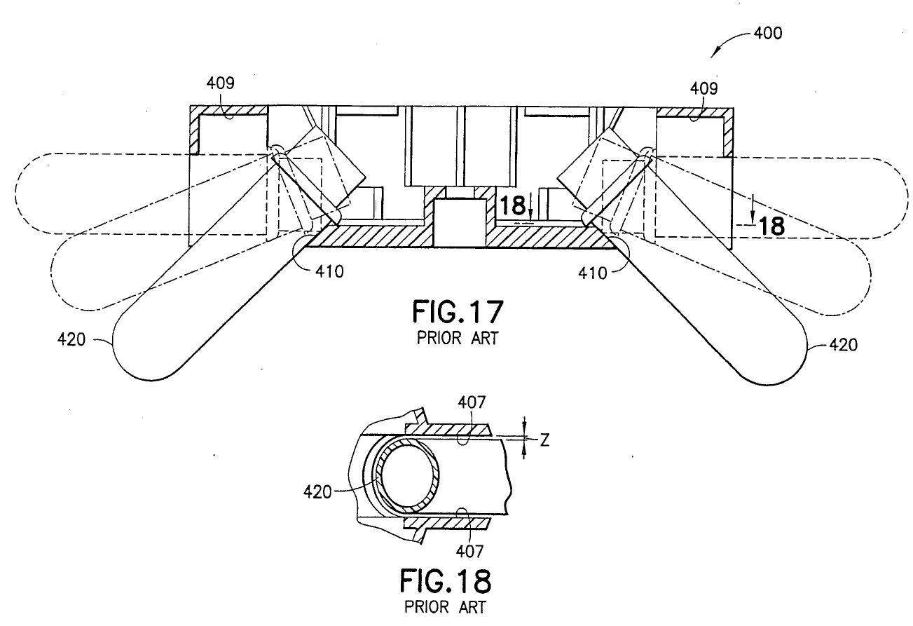

Referring specifically to FIG. 15, there is shown an embodiment of the invention wherein interchangeably mountable web forming cartridges are shown for forming differently configured tissue sealant webs for application on different specific parts of the body, using the centrifuge of the present invention.

In view of the above ready adaptively, a manufacturer may wish to market the present invention solely in kit form (housing assembly with a select sample holding unit), or in a basic kit (housing assembly with a default sample holding unit) and thereafter provide specialty kits for bioassay, film-forming or other particular customer needs.

While the afore-described specific embodiment is directed to forming a tissue sealant or rejuvenate web for application to a portion of the human body, it is to be understood that the present invention is useful for forming any biomedical web application to a portion of any living organism.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolts head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. An assembly for a centrifuge, said assembly comprising;
a rotatable tray having an axis of rotation, and comprising a plurality of orifices radially disposed from the axis, each said orifice being formed with a first contoured surface and a second contoured surface, each said orifice being sized to receive a sample tube, whereby the sample tube is disposed in the first contoured surface without rotation of the tray and the sample tube is disposed in the second contoured surface with rotation of the tray.

2. The assembly of claim 1, wherein the contoured surfaces are contiguous.

3. The assembly of claim 1, said tray further comprising a third contoured surface disposed between and contiguous with the first and second contoured surfaces.

4. The assembly of claim 1, further comprising, in combination a plurality of sample tubes, each tube comprises a centerline, and the radius and centerline subtend a first angle without tray rotation and subtend a second angle with tray rotation.

5. The assembly of claim 1, said first angle being about 90° and said second angle being about 180°.

6. The assembly of claim 3, said first and second contoured surfaces being concave and said third contoured surface being convex.

7. The assembly of claim 5, the sample tube comprises a centerline, and with the sample tube disposed with tray orifice the radius and centerline subtend a first angle without tray rotation and subtend a second angle with tray rotation, said sample tube comprising a surface, wherein the sample tube surface and tray contoured surfaces cooperatively engage so that the sample tube moves from the first angle disposition to the second angle disposition.

8. The assembly of claim 1, said tray comprising an annular body said contoured surfaces being formed in the body.

9. The assembly of claim 8, said orifices being formed in said annular body.

10. The assembly of claim 9, said tray annular body further comprising means for mounting said tray on a centrifuge.

11. The assembly of claim 6, said first, second and third surfaces being contiguous.

12. The assembly of claim 1, further comprising in combination a plurality of sample tubes, each sample tube comprising means for self-standing, and further comprising cover means for removably closing the sample tube.

13. An assembly for a centrifuge, said assembly comprising a rotatable tray, holder means for holding at least one sample tube, and means for pivotably connecting said holder means to the rotatable tray, whereby with rotation of the tray the holder means pivots from a first position to a second position.

14. The assembly of claim 13, said rotatable tray having a rotation axis, said holder means having a pivot axis, and wherein the axes are transversely disposed.

15. The assembly of claim 14, said holder comprising at least one orifice, said orifice being disposed along a radius extending from the rotation axis.

16. The assembly of claim 15, said orifice having a centerline.

17. The assembly of claim 16, said orifice centerline and said radius subtend a first angle in the first position and a second angle in the second position.

18. The assembly of claim 17, wherein the first angle is about 90°.

19. The assembly of claim 18, wherein the second angle is about 180°.

20. The assembly of claim 13, said holder means comprising means for slidability receiving a plurality of sample tubes.

21. The assembly of claim 20, said sample tubes comprise pipettes.

22. The assembly of claim 13, further comprising two holder means said two holder means being diametrically disposed.

23. The assembly of claim 22, said tray further comprising a plurality of second orifices said second orifices being sized to slidability second sample tubes, said second orifices being formed with a first contoured surface, and a second contour surface, wherein when the second sample tube is disposed in the first contoured surface and with rotation of the tray, the second sample tube is moved so as to be disposed in the second contoured surface whereby the assembly can alternatively or simultaneously centrifuge first sample tubes and second sample tubes.

24. The assembly of claim 23, further comprising a third contoured surface disposed between the first and second contoured surfaces.

25. The assembly of claim 24, wherein the first and second contoured surfaces are concave and the third contoured surface is convex.

26. The assembly of claim 25, wherein the second sample tube comprises a surface, and the second sample tube surface and orifice contoured surfaces are cooperatively slidably engaged when the second sample tube moves from the first position to the second position.

27. A sample tube assembly for a centrifuge comprising:
a body portion an upper portion and a lower portion, said body portion being disposed between the upper and lower portion, said body being formed with an interior surface for receiving a sample of flowable material for centrifugation and wherein said lower portion comprising an exterior bottom comprising an at least partially planar portion, whereby the sample tube assembly rests on the planar bottom so as to be free standing.

28. The sample tube assembly of claim 27, said lower portion having an internal surface configured to slidably contactingly receive a sample rube containing the flowable material.

29. The sample tube assembly of claim 27, said body portion comprising a cylinder having an axis, said upper portion having an exterior shoulder, said shoulder extending radially outwardly.

30. The sample tube assembly of claim 27, said exterior bottom being formed with a recess so that there are a plurality of planar portions.

31. The sample tube assembly of claim 30, wherein one planar portion is circumferentially disposed.

32. The sample tube assembly of claim 27, further comprising a cap, said cap and upper portion being cooperatively configured whereby the cap is removably disposed on the upper portion.

33. The sample tube assembly of claim 32, further comprising a sample tube containing material for centrifugation and wherein the intersection of the body and lower portion are contoured to slidably receive said sample tube.

34. The sample tube assembly of claim 27, said body and lower portions comprising an interior surface for contactingly receiving material for centrifugation.

35. The sample tube assembly of claim 34, said upper portion comprising an outwardly extending shoulder.

36. The sample tube assembly of claim 34, further comprising a cap, said cap and upper portion being cooperatively configured whereby the cap is removably disposed on the upper portion.

37. In combination:
a rotatable tray being formed with a contoured surface for receiving a sample tube and a sample tube holder having a contoured surface;
wherein the tray and sample tube contoured surfaces are cooperatively configured;
whereby with rotation of the tray, the sample tube contoured surface moves on the tray contoured surface from a first position to a second position.

38. The combination of claim 37, said tray contoured surface comprising a first contoured surface and a second contoured surface and a second contoured surface, and wherein the sample tube is disposed on the first contoured surface in the first position before tray rotation and disposed on the second portion with tray rotation.

39. The combination of claim 37, said sample tube holder having an outwardly extending shoulder, said shoulder comprises the tube holder contoured surface which contactingly engages the tray contoured surface.

40. The combination of claim 39, said sample tube holder comprises a removable cap disposed on the holder adjacent the shoulder.
